(19) United States
(12) Patent Application Publication
(10) Pub. No.: US 2021/0267214 A1
(43) Pub. Date: Sep. 2, 2021

(54) Materials and Methods for Enhanced Carbon Utilization and/or Sequestration as well as Reducing Deleterious Atmospheric Gases

(71) Applicant: Locus IP Company, LLC, Solon, OH (US)

(72) Inventors: Sean FARMER, Ft. Lauderdale, FL (US); Ken ALIBEK, Solon, OH (US); Paul S. ZORNER, Encinitas, CA (US); Karthik N. KARATHUR, Solon, OH (US); Keith HEIDECORN, Solon, OH (US)

(21) Appl. No.: 17/253,240

(22) PCT Filed: Oct. 8, 2019
(86) PCT No.: PCT/US2019/055153

§ 371 Date: Dec. 17, 2020

Related U.S. Application Data
(60) Provisional application No. 62/743,354, filed on Oct. 9, 2018.
(60) Provisional application No. 62/884,720, filed on Aug. 9, 2019.

(51) Int. Cl. A01N 63/20; C05F 11/08; A01N 63/32; A01N 63/38; A01N 63/22; A01N 63/27; B09C 1/10; A01C 21/00; A01G 22/22; B01D 53/84; B01D 53/62; B09B 1/00

(52) U.S. Cl. CPC A01N 63/20; B01D 2258/06; A01N 63/32; A01N 63/38; A01N 63/22; A01N 63/27; B09C 1/10; A01C 21/00; A01G 22/22; B01D 53/84; B01D 53/62; B09B 1/00; B09C 1/105; B09C 2101/00; B01D 2251/95; B01D 2255/804; B01D 2257/504; C05F 11/08

(57) ABSTRACT

The subject invention provides materials and methods for reducing deleterious atmospheric gases, such as greenhouse gases. In specific embodiments, the reduction in deleterious atmospheric gases is achieved via enhanced vegetative carbon utilization and storage, as well as increased carbon sequestration in soil. In some embodiments, the subject invention can be used for reducing the number of carbon credits used by an operator involved in, e.g., agriculture, livestock production, waste management or other industries. In certain embodiments, the subject invention provides customizable microbe-based products, as well as methods of using these microbe-based products for reduction of greenhouse gases and/or enhanced sequestration of carbon.

### CROSS-REFERENCE TO RELATED APPLICATION

This application claims priority to U.S. Provisional Patent Applications No. 62/743,354, filed Oct. 9, 2018; and 62/884,720, filed Aug. 9, 2019, each of which is incorporated by reference herein in its entirety.

### BACKGROUND OF THE INVENTION

Gases that trap heat in the atmosphere are called “greenhouse gases,” or “GHG,” and include carbon dioxide, methane, nitrous oxide and fluorinated gases (Climate Change Indicators in the United States, 2016, fourth edition, United States Environmental Protection Agency at 6, hereinafter “EPA report 2016”).

Carbon dioxide (CO₂) enters the atmosphere through burning fossil fuels (coal, natural gas, and oil), solid waste, trees and wood products, and also as a result of certain chemical reactions, e.g., the manufacture of cement. Carbon dioxide is removed from the atmosphere by, for example, absorption by plants as part of the biological carbon cycle.

Methane (CH₄) is emitted during the production and transport of coal, natural gas, and oil. Methane emissions also result from production of livestock animals, many of whose digestive systems comprise methanogenic microorganisms. Furthermore, other agricultural practices, and the decay of organic waste in lagoons and municipal solid waste landfills can produce methane emissions.

Nitrous oxide (N₂O) is emitted during industrial activities and during combustion of fossil fuels and solid waste. In agriculture, over-application of nitrogen-containing fertilizers and poor soil management practices can also lead to increased nitrous oxide emissions.

Fluorinated gases including, e.g., hydrofluorocarbons, perfluorocarbons, sulfur hexafluoride, and nitrogen trifluoride are synthetic, powerful greenhouse gases that are emitted from a variety of industrial processes (Overview of Greenhouse Gases 2016).

Based on recent measurements from monitoring stations around the world and measurement of older air from air bubbles trapped in layers of ice from Antarctica and Greenland, global atmospheric concentrations of, e.g., carbon dioxide, have risen significantly over the last few hundred years (EPA report 2016 at, e.g., 6, 15).

Especially since the Industrial Revolution began in the 1700s, human activity has contributed to the amount of greenhouse gases in the atmosphere by burning fossil fuels, cutting down forests, and conducting other industrial activities. Many greenhouse gases emitted into the atmosphere remain there for long periods of time ranging from a decade to many millennia. Over time these gases are removed from the atmosphere by chemical reactions or by emissions sinks, such as the oceans and vegetation that absorb greenhouse gases from the atmosphere.

Because each greenhouse gas has a different lifetime and a different ability to trap heat in the atmosphere and in order to be able to compare different gases, emissions are generally converted into carbon dioxide equivalents using each gas's global warming potential, which measures how much a given amount of the gas is estimated to contribute to global warming over a period of 100 years after being emitted.

Based on these considerations, the EPA determined that the heating effect caused by greenhouse gases, also termed “radiative forcing,” has increased by about 37% since 1990 (EPA report 2016 at 16).

Although global emissions of all major greenhouse gases increased between 1990 and 2010, the net emissions of carbon dioxide, which accounts for about three-fourths of the total global emissions, increased by 42%, whereas emissions of methane increased by about 15%, emissions of fluorinated gases doubled, and emission of nitrous oxide emissions increased by about 9% (EPA report 2016 at 14).

World leaders have attempted to curb the increase of GHG emissions through treaties and other inter-state agreements. One such attempt is through the use of carbon credit systems. A carbon credit is a generic term for a tradable certificate or permit representing the right to emit one ton of carbon dioxide, or an equivalent GHG. In a typical carbon credit system, a governing body sets quotas on the amount of GHG emissions an operator can produce. Exceeding these quotas requires the operator to purchase extra allowances from other operators who have not used all of their carbon credits.

One goal of carbon credit systems is to encourage companies to invest in more green technology, machinery and practices in order to benefit from the trade of these credits. Under the Kyoto Protocol of the United Nations Framework Convention On Climate Change (UNFCCC), a large number of countries have agreed to be bound internationally by policies for GHG reduction, including through trade of emissions credits. While the United States is not bound by the Kyoto Protocol, and while there is no central national emissions trading system in the U.S., some states, such as California and a group of northeastern states, have begun to adopt such trading schemes.

One strategy for reducing atmospheric CO₂ levels is carbon sequestration, or transfer of carbon from, e.g., the atmosphere to soil organic matter. Carbon is exchanged among the biosphere, pedosphere, hydrosphere, lithosphere, and atmosphere of the Earth and is stored in the following major sinks: (1) as organic molecules in living and dead organisms of the biosphere; (2) as CO₂ in the atmosphere; (3) as organic matter in soils; (4) as fossil fuels and sedimentary rocks such as limestone, dolomite, and chalk in the lithosphere; and (5) in the oceans as dissolved CO₂ and calcium carbonate shells of marine organisms (see, e.g., Pidwirny 2006).

Dependent on the nature of the carbon sink, carbon sequestration can be achieved by several ways: directly by inorganic chemical reactions that cause CO₂ in the form of carbonates/bicarbonates to bond with dissolved minerals and salts to form compounds such as calcium and magnesium carbonates; by plant photosynthesis, which uses sunlight to combine CO₂ from the air and water to from glucose that is stored in the tissue of plants; and indirectly by microbial decomposition of the biomass of plant and animal tissue into other compounds such as, e.g., carbohydrates, proteins, organic acids, humic substances, waxes, coal, oil, and natural gas.

Global warming may contribute to steeper temperature fluctuations, increased global precipitation, flooding and droughts, and changes in sea surface temperature and sea levels; thus, there exists a need to reduce greenhouse gases, especially CO₂, to slow these detrimental effects.

### BRIEF SUMMARY OF THE INVENTION

The subject invention provides materials and methods for reducing deleterious atmospheric gases, such as greenhouse gases. In specific embodiments, the reduction in deleterious atmospheric gases is achieved via enhanced vegetative carbon utilization and storage, as well as increased carbon sequestration in soil.

The enhanced vegetative carbon utilization can be in the form of, for example, increased foliage in plants, increased stem and/or trunk diameter, enhanced root growth, and/or increased numbers of plants.

The increased soil sequestration can be in the form of, for example, increased plant root growth, increased uptake by microorganisms of organic compounds secreted by plants (including secretions from plant roots) and improved microbial colonization of soil.

In certain embodiments, the reduction in deleterious atmospheric gases is achieved via a reduction in the number and/or activity of methanogenic microbes.

The reduction of methanogenic microbes can be in the form of, for example, enhanced management and disposal of manure and/or organic waste, as well as enhanced land and crop management.

In certain embodiments, the reduction in deleterious atmospheric gases is achieved via improved agricultural nitrogen-based fertilization practices, improved biodiversity in soil microbiota, and improved agricultural soil management.

The improved agricultural fertilization practices, soil biodiversity, and/or soil management can be in the form of a reduction of nitrogen-rich fertilizers, as well as replacement of some or all fertilizers, pesticides, and/or other soil amendments with one or more beneficial soil microorganisms.

One embodiment of the subject invention comprises conducting measurements to assess the effect of the methods of the subject invention on the generation and/or reduction in generation of greenhouse gases and/or the carbon content of, for example, an agricultural site, a turf or sod farm, a pasture or prairie, an aquatic ecosystem or a forest ecosystem.

In certain embodiments, assessing GHG generation can take the form of measuring GHG emissions before and after employing the subject methods. Measuring GHG emissions can comprise direct emissions measurement, or analysis of fuel input. Direct emissions measurements can comprise, for example, identifying polluting operational activities and measuring the emissions of those activities directly through Continuous Emissions Monitoring Systems (CEMS). Fuel input analysis can comprise calculating the quantity of energy resources used (e.g., amount of electricity, fuel, wood, biomass, etc., consumed), determining the content of, for example, carbon, in the fuel source, and applying that carbon content to the quantity of the fuel consumed to determine the amount of emissions.

In certain embodiments, carbon content of a site, e.g., an agricultural site, a turf or sod farm, a pasture, an aquatic ecosystem or a forest ecosystem, can be measured by, for example, quantifying the aboveground and/or below-ground biomass of plants. In general, the carbon concentration of, for example, a tree, is assumed to be from about 40 to 50% of the biomass.

Biomass quantification can take the form of, for example, harvesting plants in a sample area and measuring the weight of the different parts of the plant before and after drying. Biomass quantification can also be carried out using non-destructive, observational methods, such as measuring, e.g., trunk diameter, height, volume, and other physical parameters of the plant. Remote quantification can also be used, such as, for example, laser profiling and analysis by drones.

In some embodiments, carbon content of an agricultural site, a sod or turf farm, a pasture or prairie, an aquatic ecosystem or a forest ecosystem, can further comprise sampling and measuring carbon content of litter, woody debris and/or soil organic matter of a sampling area.

In some embodiments, the subject invention can be used for reducing the number of carbon credits used by an operator involved in, e.g., agriculture, livestock production, waste management, forestry/reforestation, aviation, oil and gas production, and other industries.

In certain embodiments, the subject invention provides microbe-based products, as well as methods of using these microbe-based products for reduction of atmospheric greenhouse gases, increased utilization of carbon and/or enhanced sequestration of carbon. In one embodiment, the subject invention provides microbe-based compositions that can enhance the properties of soil, enhance the above- and below-ground biomass of plants, and control, for example, methanogenic microbes. Advantageously, the microbe-based products and methods of the subject invention are environmentally-friendly, non-toxic and cost-effective.

### BRIEF DESCRIPTION OF THE DRAWINGS

FIGS. 1A-1B show the difference between fibrous root biomass of untreated control citrus trees (“Grower's Practice”) and citrus trees treated with a composition according to embodiments of the subject invention. 1A depicts the root biomass measurements of treated and untreated grapefruit trees. 1B depicts the root biomass measurements of treated and untreated orange trees.

FIGS. 2A-2B show the difference between canopy density rating of untreated control citrus trees and citrus trees treated with a composition according to embodiments of the subject invention. 2A depicts canopy density rating for treated and untreated young orange trees. 2B depicts canopy density rating for treated and untreated mature orange trees.

FIG. 3 shows the difference between trunk caliper of untreated control almond trees and almond trees treated with a composition according to embodiments of the subject invention.

FIGS. 4A-4B show the difference between dry root mass of untreated control sod and sod treated with a composition according to embodiments of the subject invention. 4A shows dry root mass of treated and untreated ryegrass sod. 4B shows dry root mass of treated and untreated blue rye sod.

FIGS. 5A-5B show the difference between dry root mass and chlorophyll rating of untreated control sod and sod treated with a composition according to the subject invention. 5A shows dry root mass of treated and untreated sod. 5B shows chlorophyll rating (relative greenness) of treated and untreated sod.

FIGS. 6A-6B show the difference between chlorophyll content, leaf length and leaf width of untreated control tobacco plants and tobacco plants treated with a composition according to embodiments of the subject invention. 6A shows the chlorophyll content of treated and untreated tobacco. 6B shows the leaf length (top) and width (bottom) of treated and untreated tobacco.

FIGS. 7A-7B show the difference between fibrous root wet mass and root length and width of untreated control tobacco plants and tobacco plants treated with a composition according to embodiments of the subject invention. 7A shows fibrous root wet mass of treated and untreated tobacco. 7B shows root length and width of treated and untreated tobacco.

FIGS. 8A-8B show the wet root mass (8A) and the density of root fibers (8B) of untreated plants (left) and of plants treated with a composition according to embodiments of the subject invention (right).

FIG. 9 shows the bulk density results from analysis of soils in untreated plots compared to plots treated with a composition according to embodiments of the subject invention.

FIG. 10 shows total organic carbon (TOC) results from analysis of soils in untreated control plots compared to plots treated with a composition according to embodiments of the subject invention.

FIG. 11 shows CO₂ equivalents stored in soil carbon pool in untreated control plots compared to plots treated with a composition according to embodiments of the subject invention.

FIG. 12 shows soil nitrous oxide emissions measured from plots treated with compositions according to embodiments of the subject invention, NPK fertilizer, and/or untreated plots.

### DETAILED DESCRIPTION OF THE INVENTION

The subject invention provides materials and methods for reducing deleterious atmospheric gases, such as greenhouse gases. In specific embodiments, the reduction in deleterious atmospheric gases is achieved via enhanced vegetative carbon utilization and storage, as well as increased carbon sequestration in soil.

In certain embodiments, the reduction in deleterious atmospheric gases is achieved via a reduction in methanogenic microbes.

In certain embodiments, the reduction in deleterious atmospheric gases is achieved via improved agricultural nitrogen-based fertilization practices and improved agricultural soil management (e.g., through improved biodiversity of soil microbiota).

One embodiment of the subject invention comprises conducting measurements to assess the effect of the methods of the subject invention on the generation and/or reduction in generation of greenhouse gases and/or the carbon content of, for example, an agricultural site, a turf or sod farm, a pasture, an aquatic ecosystem or a forest ecosystem.

In some embodiments, the subject invention can be used for reducing the number of carbon credits used by an operator involved in, e.g., agriculture, livestock production, forestry/reforestation, waste management, aviation, oil and gas production, or other industries.

In one embodiment, the subject invention provides microbe-based compositions that can enhance the properties of soil, enhance the above- and below-ground biomass of plants, and control, for example, methanogenic microbes.

### Selected Definitions

The subject invention utilizes “microbe-based compositions,” meaning a composition that comprises components that were produced as the result of the growth of microorganisms or other cell cultures. Thus, the microbe-based composition may comprise the microbes themselves and/or by-products of microbial growth. The microbes may be in a vegetative state, in spore or conidia form, in hyphae form, in any other form of propagule, or a mixture of these. The microbes may be planktonic or in a biofilm form, or a mixture of both. The by-products of growth may be, for example, metabolites, cell membrane components, proteins, and/or other cellular components. The microbes may be intact or lysed. In preferred embodiments, the microbes are present, with growth medium in which they were grown, in the microbe-based composition. The microbes may be present at, for example, a concentration of at least 1×10⁴, 1×10⁵, 1×10⁶, 1×10⁷, 1×10⁸, 1×10⁹, 1×10¹⁰, 1×10¹¹, 1×10¹² or 1×10¹³ or more CFU per gram or per ml of the composition.

The subject invention further provides “microbe-based products,” which are products that are to be applied in practice to achieve a desired result. The microbe-based product can be simply the microbe-based composition harvested from the microbe cultivation process. Alternatively, the microbe-based product may comprise further ingredients that have been added. These additional ingredients can include, for example, stabilizers, buffers, appropriate carriers, such as water, salt solutions, or any other appropriate carrier, added nutrients to support further microbial growth, non-nutrient growth enhancers and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

As used herein, “harvested” in the context of fermentation of a microbe-based composition refers to removing some or all of the microbe-based composition from a growth vessel.

As used herein, a “biofilm” is a complex aggregate of microorganisms, wherein the cells adhere to each other and/or to surfaces. In some embodiments, the cells secrete a polysaccharide barrier that surrounds the entire aggregate. The cells in biofilms are physiologically distinct from planktonic cells of the same organism, which are single cells that can float or swim in liquid medium.

As used herein, an “isolated” or “purified” compound is substantially free of other compounds, such as cellular material, with which it is associated in nature. A purified or isolated polynucleotide (ribonucleic acid (RNA) or deoxyribonucleic acid (DNA)) is free of the genes or sequences that flank it in its naturally-occurring state. A purified or isolated polypeptide is free of the amino acids or sequences that flank it in its naturally-occurring state. “Isolated” in the context of a microbial strain means that the strain is removed from the environment in which it exists in nature. Thus, the isolated strain may exist as, for example, a biologically pure culture, or as spores (or other forms of the strain) in association with a carrier.

As used herein, a “biologically pure culture” is a culture that has been isolated from materials with which it is associated in nature. In a preferred embodiment, the culture has been isolated from all other living cells. In further preferred embodiments, the biologically pure culture has advantageous characteristics compared to a culture of the same microbe as it exists in nature. The advantageous characteristics can be, for example, enhanced production of one or more growth by-products.

In certain embodiments, purified compounds are at least 60% by weight the compound of interest. Preferably, the preparation is at least 75%, more preferably at least 90%, and most preferably at least 99%, by weight the compound of interest. For example, a purified compound is one that is at least 85%, 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

A “metabolite” refers to any substance produced by metabolism (e.g., a growth by-product) or a substance necessary for taking part in a particular metabolic process. A metabolite can be an organic compound that is a starting material, an intermediate in, or an end product of metabolism. Examples of metabolites include, but are not limited to, biosurfactants, biopolymers, enzymes, acids, solvents, alcohols, proteins, vitamins, minerals, microelements, and amino acids.

As used herein, “modulate” means to cause an alteration (e.g., increase or decrease). Such alterations are detected by standard art known methods.

Ranges provided herein are understood to be shorthand for all of the values within the range. For example, a range of 1 to 20 is understood to include any number, combination of numbers, or sub-range from the group consisting of 1, 2, 3, 4, 5, 6, 7, 8, 9, 10, 11, 12, 13, 14, 15, 16, 17, 18, 19, 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein, “reduction” refers to a negative alteration, and the term “increase” refers to a positive alteration, wherein the negative or positive alteration is at least 0.25%, 0.5%, 1%, 5%, 10%, 15%, 20%, 25%, 30%, 35%, 40%, 45%, 50%, 55%, 60%, 70%, 75%, 80%, 85%, 90%, 95%, or 100%.

As used herein, “reference” refers to a standard or control condition.

As used herein, “surfactant” refers to a compound that lowers the surface tension (or interfacial tension) between phases. Surfactants act as, e.g., detergents, wetting agents, emulsifiers, foaming agents, and dispersants. A “biosurfactant” is a surfactant produced by a living organism.

As used herein, “agriculture” means the cultivation and breeding of plants, algae and/or fungi for food, fiber, biofuel, medicines, cosmetics, supplements, ornamental purposes and other uses. According to the subject invention, agriculture can also include horticulture, landscaping, gardening, plant conservation, forestry and reforestation, pasture and prairie restoration, orcharding, arboriculture, and agronomy. Further included in agriculture is the care, monitoring and maintenance of soil.

As used herein, “enhancing” means improving or increasing. For example, enhanced plant health means improving the plant's ability grow and thrive, which includes increased seed germination and/or emergence, improved ability to ward off pests and/or diseases, and improved ability to survive environmental stressors, such as droughts and/or overwatering. Enhanced plant growth and/or enhanced plant biomass means increasing the size and/or mass of a plant both above and below the ground (e.g., increased canopy/foliar volume, height, trunk caliper, branch length, shoot length, protein content, root size/density and/or overall growth index), and/or improving the ability of the plant to reach a desired size and/or mass. Enhanced yields mean improving the end products produced by the plants in a crop, for example, by increasing the number and/or size of fruits, leaves, roots and/or tubers per plant, and/or improving the quality of the fruits, leaves, roots and/or tubers (e.g., improving taste, texture, brix, chlorophyll content and/or color).

As used here, the term “plant” includes, but is not limited to, any species of woody, ornamental or decorative, crop or cereal, fruit or vegetable, fruit plant or vegetable plant, flower or tree, macroalga or microalga, phytoplankton and photosynthetic algae (e.g., green algae Chlamydomonas reinhardtii). “Plant” also includes a unicellular plant (e.g. microalga) and a plurality of plant cells that are largely differentiated into a colony (e.g. volvox) or a structure that is present at any stage of a plant's development. Such structures include, but are not limited to, a fruit, a seed, a shoot, a root, a stem, a leaf, a flower, etc. Furthermore, the plant can be standing alone, for example, in a lawn or garden, or it can be one of many plants, for example, as part of an orchard, forest or crop. In exemplary embodiments, the plant is a crop plant selected from citrus, tomato, sod, turf, potato, sugarcane, grapes, lettuce, almond, onion, carrot, berries and cotton; and/or a tree growing in a grove, forest or orchard; a hydrophyte or macrophyte growing in an aquatic environment; and/or a grass, shrub or herb growing in a field, sod or turf farm, prairie or a pasture.

The term “plant tissue” includes differentiated and undifferentiated tissues of plants including those present in roots, shoots, leaves, pollen, seeds and tumors or galls, as well as cells in culture (e.g., single cells, protoplasts, embryos, callus, etc.). Plant tissue may be in planta, in organ culture, tissue culture, or cell culture. The term “plant part” as used herein refers to a plant structure or a plant tissue.

As used herein “preventing” or “prevention” of a situation or occurrence means delaying, inhibiting, suppressing, forestalling, and/or minimizing the onset, extensiveness or progression of the situation or occurrence. Prevention can include, but does not require, indefinite, absolute or complete prevention, meaning the sign or symptom may still develop at a later time. Prevention can include reducing the severity of the onset of such a disease, condition or disorder, and/or inhibiting the progression of the condition or disorder to a more severe condition or disorder.

As used herein, the term “control” used in reference to a pest means killing, disabling, immobilizing, or reducing population numbers of a pest, or otherwise rendering the pest substantially incapable of causing harm.

As used herein, a “pest” is any organism, other than a human, that is destructive, deleterious and/or detrimental to humans or human concerns (e.g., agriculture, horticulture). In some, but not all instances, a pest may be a pathogenic organism. Pests may cause or be a vector for infections, infestations and/or disease, or they may simply feed on or cause other physical harm to living tissue. Pests may be single- or multi-cellular organisms, including but not limited to, viruses, fungi, bacteria, parasites, protozoa and/or nematodes.

As used herein, a “soil amendment” or a “soil conditioner” is any compound, material, or combination of compounds or materials that are added into soil to enhance the properties of the soil and/or rhizosphere. Soil amendments can include organic and inorganic matter, and can further include, for example, fertilizers, pesticides and/or herbicides. Nutrient-rich, well-draining soil is essential for the growth and health of plants, and thus, soil amendments can be used for enhancing the plant biomass by altering the nutrient and moisture content of soil. Soil amendments can also be used for improving many different qualities of soil, including but not limited to, soil structure (e.g., preventing compaction); improving the nutrient concentration and storage capabilities; improving water retention in dry soils; and improving drainage in waterlogged soils.

As used herein, an “abiotic stressor” is a non-living condition that has a negative impact on a living organism in a specific environment. The abiotic stressor must influence the environment beyond its normal range of variation to adversely affect the population performance or individual physiology of the organism in a significant way. Examples of abiotic stressors include, but are not limited to, drought, extreme temperatures (high or low), flood, high winds, natural disasters (e.g., hurricanes, avalanches, tornadoes), soil pH changes, high radiation, compaction of soil, pollution, and others. Alternatively, a “biotic stressor” is damaging and/or harmful action towards a living organism by another living organism. Biotic stressors can include, for example, damage and/or disease caused by a pest, competition with other organisms for resources and/or space, and various human activities.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially” of the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

All references cited herein are hereby incorporated by reference in their entirety.

### Methods for Reducing Deleterious Atmospheric Gases

The subject invention provides methods for reducing deleterious atmospheric gases, such as greenhouse gases (GHGs). The GHGs can be, for example, carbon dioxide, nitrous oxide and/or methane.

Advantageously, in some embodiments, the subject invention can be used for reducing the number of carbon credits used by an operator involved in, e.g., agriculture, livestock production, forestry/reforestation, waste management, aviation, oil and gas production, or other industries.

In a specific embodiment, methods are provided for reducing the amount of a deleterious atmospheric gas present in the earth's atmosphere, the method comprising: applying a composition comprising one or more beneficial microorganisms and/or microbial growth by-products, and, optionally, nutrients for promoting microbial growth (e.g., prebiotics), to a site that is a source of the deleterious atmospheric gas.

In some embodiments, the site contains organic matter that can be converted into a deleterious atmospheric gas emission through natural processes, such as, for example, respiration or decomposition. The subject invention can be used to, for example, control and/or prevent the release of the deleterious atmospheric gas by-products of these processes.

In some embodiments, prior to applying a composition to the site, the method comprises assessing the site for local conditions, determining a preferred formulation for the composition (e.g., the type, combination and/or ratios of microorganisms and/or growth by-products) that is customized for the local conditions, and producing the composition with the preferred formulation.

The local conditions can include, for example, soil conditions (e.g., soil type, species of soil microbiota, amount and/or type of soil organic content, amount and/or type of GHG precursor substrates, amount and/or type of fertilizers or other soil additives or amendments present); crop and/or plant conditions (e.g., types, numbers, age and/or health of plants being grown); environmental conditions (e.g., current climate, season, or time of year); amount and type of GHG emissions at the site; mode and/or rate of application of the composition, and others as are relevant to the site.

After assessment, a preferred formulation for the composition can be determined so that the composition can be customized for these local conditions. The composition is then cultivated, preferably at a microbe growth facility that is within 300 miles of the site of application, preferably within 200 miles, even more preferably within 100 miles.

In some embodiments the local conditions are assessed periodically, for example, once annually, biannually, or even monthly. In this way, the composition formula can be modified in real time as necessary to meet the unique needs of the changing local conditions.

### Modes of Application

As used herein, “applying” a composition or product to a site refers to contacting a composition or product with a site such that the composition or product can have an effect on that site. The effect can be due to, for example, microbial growth and colonization, and/or the action of a metabolite, enzyme, biosurfactant or other microbial growth by-product. The mode of application depends upon the formulation of the composition, and can include, for example, spraying, pouring, sprinkling, injecting, spreading, mixing, dunking, fogging and misting. Formulations can include, for example, liquids, dry and/or wettable powders, flowable powders, dusts, granules, pellets, emulsions, microcapsules, steaks, oils, gels, pastes and/or aerosols. In an exemplary embodiment, the composition is applied after the composition has been prepared by, for example, dissolving the composition in water.

In one embodiment, the site to which the composition is applied is the soil (or rhizosphere) in which plants will be planted or are growing (e.g., a crop, a field, an orchard, a grove, a pasture/prairie or a forest). The compositions of the subject invention can be pre-mixed with irrigation fluids, wherein the compositions percolate through the soil and can be delivered to, for example, the roots of plants to influence the root microbiome.

In one embodiment, the compositions are applied to soil surfaces, with or without water, where the beneficial effect of the soil application can be activated by rainfall, sprinkler, flood, or drip irrigation.

In one embodiment, the site is a manure lagoon where livestock waste is deposited and/or processed. In one embodiment, the site is a rice paddy, or a similar agricultural operation where crop fields are flooded during growing season. Application can comprise contacting a composition of the subject invention with the liquids of the lagoon and/or flooded paddy by pouring, spraying, injecting, etc., and optionally mixing the composition therein.

In one embodiment, the site is a plant or plant part. The composition can be applied directly thereto as a seed treatment, or to the surface of a plant or plant part (e.g., to the surface of the roots, tubers, stems, flowers, leaves, fruit, or flowers). In a specific embodiment, the composition is contacted with one or more roots of the plant. The composition can be applied directly to the roots, e.g., by spraying or dunking the roots, and/or indirectly, e.g., by administering the composition to the soil in which the plant grows (or the rhizosphere). The composition can be applied to the seeds of the plant prior to or at the time of planting, or to any other part of the plant and/or its surrounding environment.

In one embodiment, wherein the method is used in a large scale setting, such as in a citrus grove, a pasture or prairie, a forest, a sod or turf farm, or an agricultural crop, the method can comprise administering the composition into a tank connected to an irrigation system used for supplying water, fertilizers, pesticides or other liquid compositions. Thus, the plant and/or soil surrounding the plant can be treated with the composition via, for example, soil injection, soil drenching, using a center pivot irrigation system, with a spray over the seed furrow, with micro-jets, with drench sprayers, with boom sprayers, with sprinklers and/or with drip irrigators. Advantageously, the method is suitable for treating hundreds of acres of land.

In one embodiment, wherein the method is used in a smaller scale setting, such as in a home garden or greenhouse, the method can comprise pouring the composition (mixed with water and other optional additives) into the tank of a handheld lawn and garden sprayer and spraying soil or another site with the composition. The composition can also be mixed into a standard handheld watering can and poured onto a site.

Plants and/or their environments can be treated at any point during the process of cultivating the plant. For example, the composition can be applied to the soil prior to, concurrently with, or after the time when seeds are planted therein. It can also be applied at any point thereafter during the development and growth of the plant, including when the plant is flowering, fruiting, and during and/or after abscission of leaves.

### Reduction in Deleterious Atmospheric Gases

In some embodiments, the reduction in deleterious atmospheric gases according to the subject methods is achieved via enhanced vegetative carbon utilization and storage, as well as increased carbon sequestration in soil. For example, the enhanced vegetative carbon utilization can be in the form of, for example, increased foliage in plants, increased stem and/or trunk diameter, enhanced root growth, and/or increased numbers of plants.

Additionally, the increased soil sequestration can be in the form of, for example, increased plant root growth, increased uptake by microorganisms of organic compounds secreted by plants (including secretions from plant roots) and improved microbial colonization of soil and roots.

As used herein, “reduction” refers to a negative alteration, and the term “increase” refers to a positive alteration, wherein the negative or positive alteration is at least 0.01%, 0.1%, 0.25%, 0.5%, 1%, 5%, 10%, 15%, 20%, 25%, 30%, 35%, 40%, 45%, 50%, 55%, 60%, 70%, 75%, 80%, 85%, 90%, 95%, or 100%.

In some embodiments, the desired reduction is achieved within a relatively short time period, for example, within 1 week, 2 weeks, 3 weeks or 4 weeks. In some embodiments, the desired reduction is achieved within, for example, 1 month, 2 months, 3 months, 4 months, 5 months or 6 months after employing the subject methods. In some embodiments, the desired reduction is achieved within 1 year, 2 years, 3 years, 4 years, or 5 years after employing the subject methods.

In a specific embodiment, the method is used for reducing atmospheric carbon dioxide. By increasing plant biomass above and below ground, the plants act as carbon sinks by fixing carbon during photosynthesis and storing carbon as biomass. Furthermore, the increased plant root biomass not only increases the root structures upon which microbes can settle, but increases the secretion rates and the amounts of sugar and other nutrients exuded from the plant roots, which feed the applied and native microbial biomass. The microbes in turn convert plant-based materials to increased levels of carbon stored in the soil. Thus, the stimulated microbial population below-ground (both added and native) further serves as a storage system for carbon. In a specific embodiment, the microbial cell biomass is yeast biomass.

In certain embodiments, the reduction in deleterious atmospheric gases is achieved via improved agricultural fertilization practices and improved agricultural soil management.

The improved agricultural fertilization practices can be in the form of, for example, a reduction of nitrogen-rich fertilizers, as well as replacement of some or all fertilizers, pesticides, and/or other soil amendments with a composition comprising one or more environmentally-friendly soil microorganisms. Advantageously, reducing fertilizer and other chemical applications reduces the amount of these chemicals that pollute soils and ground water when left unabsorbed by plants, and further reduces their runoff into other water sources. Furthermore, reducing fertilizer applications reduce the amount of nitrous oxide and carbon dioxide soil emissions resulting from such applications.

The subject methods can increase the above- and below-ground biomass of plants, including, for example, increased foliage volume, increased stem and/or trunk diameter, enhanced root growth and/or density, and/or increased numbers of plants. In one embodiment, this is achieved by improving the overall hospitability of the rhizosphere in which a plant's roots are growing, for example, by improving the nutrient and/or moisture retention properties of the rhizosphere.

Accordingly, the subject invention can benefit reforestation efforts, as well as efforts to restore depleted prairies and/or pastureland. In some embodiments, the amount of vegetation in a prairie/pastureland and/or forest has been depleted due to anthropogenic causes, such as over-grazing by livestock, logging, commercial, urban and/or residential development, and/or dumping. In some embodiments, the amount of vegetation is depleted due to fire, disease or other natural and/or environmental stressors.

Additionally, in one embodiment, the method can be used to inoculate soil and/or a plant's rhizosphere with a beneficial microorganism. The microorganisms of the subject microbe-based compositions can promote colonization of the roots and/or rhizosphere, as well as the vascular system of the plant, by, for example, aerobic bacteria, yeasts, and/or fungi.

In certain embodiments, the method can be used to remove nitrous oxide directly from the air and/or soil. For example, certain microorganisms according to the subject invention (e.g., Dyadobacter fermenters) are capable of reducing nitrous oxide into nitrogen in soil without denitrification. Denitrification is the reduction of nitrates and nitrites into molecular nitrogen. The intermediates of the reduction process include nitrogen oxide products, such as nitrous oxide, which can leak into the atmosphere.

In one embodiment, the promotion of colonization can lead to improved biodiversity of the soil microbiome. As used herein, improving the biodiversity refers to increasing the variety of microbial species within the soil. Preferably, improved biodiversity comprises increasing the ratio of aerobic bacterial species, yeast species, and/or fungal species to anaerobic microorganisms in the soil.

For example, in one embodiment, the microbes of the subject composition can colonize roots, the soil and/or the rhizosphere and encourage colonization of other nutrient-fixing microbes, such as Rhizobium and/or Mycorrhizae, and other endogenous and/or exogenous microbes that promote plant biomass accumulation.

In one embodiment, soil biodiversity and root colonization can be further enhanced through the application of a biostimulant, or a substance that promotes increased growth rates of a microorganism, to the soil.

In one embodiment, improved soil biodiversity promotes enhanced nutrient solubilization and/or uptake. For example, certain aerobic bacterial species can acidify the soil and solubilize NPK fertilizers into plant-usable forms.

In yet another embodiment, the method can be used to fight off and/or discourage colonization of the rhizosphere by soil microorganisms that are deleterious or that might compete with beneficial soil microorganisms. For example, when more aerobic microorganisms are present in the soil, less anaerobic microorganisms, such as nitrate-reducing microorganisms, can thrive and produce deleterious atmospheric by-products, such as nitrous oxide.

In one embodiment, the method can be used for enhancing penetration of beneficial molecules through the outer layers of root cells, for example, at the root-soil interface of the rhizosphere.

The subject invention can be used to improve any number of qualities of any type of soil, for example, clay, sandy, silty, peaty, chalky, loam soil, and/or combinations thereof. Furthermore, the methods and compositions can be used for improving the quality of dry, waterlogged, porous, depleted, compacted soils and/or combinations thereof. Soil can include the soil present in the rhizosphere or soil that lies outside of the rhizosphere.

In one embodiment, the method can be used for improving the drainage and/or dispersal of water in waterlogged soils. In one embodiment, the method can be used for improving water retention in dry soil.

In one embodiment, the method can be used for improving nutrient retention in porous and/or depleted soils.

In one embodiment, the method can be used for improving the structure and/or nutrient content of eroded soils.

In one embodiment, the method can be used to reduce and/or replace a chemical or synthetic fertilizer, wherein the composition comprises a microorganism capable of fixing, solubilizing and/or mobilizing nitrogen, potassium, phosphorous (or phosphate) and/or other micronutrients in soil.

In certain embodiments, the reduction in deleterious atmospheric gases is achieved via a reduction in methanogenic microbes of both animal and environmental origin. The reduction of methanogenic microbes can be in the form of, for example, enhanced management and disposal of manure and/or organic waste, as well as enhanced land and crop management.

In one embodiment, the site to which the subject composition is applied is a lagoon. Manure lagoons are anaerobic basins filled with animal waste from livestock operations. Some lagoons are also used for pretreating industrial and/or municipal wastewaters. Due to the presence of methanogenic microorganisms that feed on the organic matter in the wastewater, lagoons are a large source of methane emissions.

In one embodiment, the site to which the subject composition is applied is a rice paddy. Standard rice growing practice entails flooding of rice fields during the growing season. During flooding, however, methanogenic microorganisms thrive on decaying organic matter in the water, thus releasing methane emissions in large amounts.

By applying a composition of the subject invention to the water and other liquids in a lagoon or a rice paddy, the subject methods can effectively reduce atmospheric methane emissions through the control of methanogenic microorganisms. For example, in one embodiment, the composition can exhibit antibacterial properties against the methanogens when the composition comprises a biosurfactant and/or a microorganism that produces biosurfactants. In another embodiment, when the composition comprises a killer yeast, e.g., Wickerhamomyces anomalus, the composition can be effective at controlling methanogenic microorganisms due to the exotoxins secreted by the killer yeast.

One embodiment of the subject methods comprise conducting measurements to assess the effect of a composition on the generation, or reduction in generation, of greenhouse gases and/or the carbon content of a site that is the source of a deleterious atmospheric gas.

Measurements can be conducted at a certain time point after application of the microbe-based composition to the site. In some embodiments, the measurements are conducted after about 1 week or less, 2 weeks or less, 3 weeks or less, 4 weeks or less, 30 days or less, 60 days or less, 90 days or less, 120 days or less, 180 days or less, and/or 1 year or less.

Furthermore, the measurements can be repeated over time. In some embodiments, the measurements are repeated daily, weekly, monthly, bi-monthly, semi-monthly, semi-annually, and/or annually.

In certain embodiments, assessing GHG generation can take the form of measuring GHG emissions from a site. Gas chromatography and electron capture are commonly used for testing samples in a lab setting. In certain embodiments, GHG emissions can also be conducted in the field, using, for example, flux measurements and/or in situ soil probing. Flux measurements analyze the emission of gases from the soil surface to the atmosphere, for example, using chambers that enclose an area of soil and then estimate flux by observing the accumulation of gases inside the chamber over a period of time. Probes can be used to generate a soil gas profile, starting with a measurement of the concentration of the gases of interest at a certain depth in the soil, and comparing it directly between probes and ambient surface conditions (Brummell and Siciliano 2011, at 118).

Measuring GHG emissions can also comprise other forms of direct emissions measurement and/or analysis of fuel input. Direct emissions measurements can comprise, for example, identifying polluting operational activities (e.g., fuel-burning automobiles) and measuring the emissions of those activities directly through Continuous Emissions Monitoring Systems (CEMS). Fuel input analysis can comprise calculating the quantity of energy resources used (e.g., amount of electricity, fuel, wood, biomass, etc., consumed) determining the content of, for example, carbon, in the fuel source, and applying that carbon content to the quantity of the fuel consumed to determine the amount of emissions.

In certain embodiments, carbon content of a site where plants are growing, e.g., agricultural site, crop, sod or turf farm, pasture/prairie or forest, can be measured by, for example, quantifying the aboveground and/or below-ground biomass of plants. In general, the carbon concentration of, for example, a tree, is assumed to be from about 40 to 50% of the biomass.

Biomass quantification can take the form of, for example, harvesting plants in a sample area and measuring the weight of the different parts of the plant before and after drying. Biomass quantification can also be carried out using non-destructive, observational methods, such as measuring, e.g., trunk diameter, height, volume, and other physical parameters of the plant. Remote quantification can also be used, such as, for example, laser profiling and/or drone analysis.

In some embodiments, carbon content of a site can further comprise sampling and measuring carbon content of litter, woody debris and/or soil of a sampling area. Soil, in particular, can be analyzed, for example, using dry combustion to determine percent total organic carbon (TOC); by potassium permanganate oxidation analysis for detecting active carbon; and by bulk density measurements (weight per unit volume) for converting from percent carbon to tons/acre.

In some embodiments, the subject invention can be used for reducing the number of carbon credits used by an operator involved in, e.g., agriculture, forestry/reforestation, livestock production, waste management, aviation, oil and gas, or other industries.

### Compositions

In one embodiment, the subject invention provides compositions comprising one or more microorganisms and/or microbial growth by-products, wherein the one or more microorganisms are beneficial, non-pathogenic, soil-colonizing microorganisms. The composition can be used for reducing greenhouse gases, improving carbon utilization, enhancing sequestration of carbon and/or controlling methanogenic microorganisms. In some embodiments, the composition comprises one or more microbes that can also be useful for enhancing rhizosphere properties, enhancing plant biomass, and/or controlling, for example, methanogenic microorganisms.

In preferred embodiments, the microbial growth by-products are biosurfactants and/or enzymes, although other metabolites may also be present in the composition.

Advantageously, in preferred embodiments, the microbe-based compositions according to the subject invention are non-toxic and can be applied in high concentrations without causing irritation to, for example, the skin or digestive tract of a human or other non-pest animal. Thus, the subject invention is particularly useful where application of the microbe-based compositions occurs in the presence of living organisms, such as growers and livestock.

In one embodiment, multiple microorganisms can be used together, where the microorganisms create a synergistic benefit towards GHG reduction and/or carbon sequestration.

The species and ratio of microorganisms and other ingredients in the composition can be customized and optimized for specific local conditions at the time of application, such as, for example, which soil type, plant and/or crop is being treated; what season, climate and/or time of year it is when a composition is being applied; and what mode and/or rate of application is being utilized. Thus, the composition can be customizable for any given site.

In one embodiment, the composition comprises a yeast, such as Starmerella bombicola, Saccharomyces boulardii, Pseudozyma aphidis, and/or a Pichia spp. yeast (e.g., Pichia occidentalis, Pichia kudriavzevii and/or Pichia guilliermondii (Meyerozyma guilliermondii)).

In one embodiment, the composition comprises at least one killer yeast. Preferably, the composition comprises a non-pathogenic “killer yeast” strain, such as Wickerhamomyces anomalus, or other yeasts within the same family and/or genus. W. anomalus is capable of producing a variety of metabolites, including enzymes such as phytase, glycosidases, and exo beta-1, 3 glucanase, as well as biosurfactants, such as phospholipids.

In one embodiment, the composition comprises a fungus, such as Pleurolus ostreatus, Lentinuda edodes, or a Trichoderma spp. fungus, such as, for example, T. harzianum, T. viride, T. hamatum, and/or T. reesei.

In one embodiment, the composition comprises a bacterium such as Pseudomonas chlororaphis, or a Bacillus spp. bacterium, such as, for example, B. subtilis and/or B. amyloliquefaciens (e.g., B. amyloliquefaciens subsp. locus).

In one embodiment, a myxobacterium is included, wherein the myxobacterium is Myxococcus xanthus.

In one embodiment, the composition comprises a microorganism capable of fixing, solubilizing and/or mobilizing nitrogen, potassium, phosphorous (or phosphate) and/or other micronutrients in soil. In one embodiment, a potassium-mobilizing bacteria can be included, such as, for example, Frateuria aurantia. In one embodiment, a nitrogen-fixing bacteria can be included, such as, for example, Azotobacter vinelandii, Paenibacillus polymyxa and/or Bacillus amyloliquefaciens.

In one embodiment, the composition comprises a non-denitrifying microorganism capable of converting nitrous oxide from the atmosphere into nitrogen in the soil, such as, for example, Dyadobacter fermenters.

In a specific embodiment, the concentration of each microorganism included in the composition is 1×10⁶ to 1×10¹³ CFU/g, 1×10⁷ to 1×10¹² CFU/g, 1×10⁸ to 1×10¹¹ CFU/g, or 1×10⁹ to 1×10¹⁰ CFU/g of the composition.

In one embodiment, the total microbial cell concentration of the composition is at least 1×10⁶ CFU/g, including up to 1×10⁹ CFU/g, 1×10¹⁰, 1×10¹¹, 1×10¹² and/or 1×10¹³ or more CFU/g. In one embodiment, the microorganisms of the subject composition comprise about 5 to 20% of the total composition by weight, or about 8 to 15%, or about 10 to 12%.

The composition can comprise the leftover fermentation substrate and/or purified or unpurified growth by-products, such as enzymes, biosurfactants and/or other metabolites. The microbes can be live or inactive.

The microbes and microbe-based compositions of the subject invention have a number of beneficial properties that are useful for, e.g., increasing plant biomass and controlling methanogens. For example, the compositions can comprise products resulting from the growth of the microorganisms, such as biosurfactants, proteins and/or enzymes, either in purified or crude form. Furthermore, the microorganisms can enhance plant growth, induce auxin production, enable solubilization, absorption and/or balance of nutrients in the soil, and protect plants from pests and pathogens.

In one embodiment, the microorganisms of the subject composition are capable of producing a biosurfactant. In another embodiment, biosurfactants can be produced separately by other microorganisms and added to the composition, either in purified form or in crude form. Crude form biosurfactants can comprise, for example, biosurfactants and other products of cellular growth in the leftover fermentation medium resulting from cultivation of a biosurfactant-producing microbe. This crude form biosurfactant composition can comprise from about 0.001% to about 90%, about 25% to about 75%, about 30% to about 70%, about 35% to about 65%, about 40% to about 60%, about 45% to about 55%, or about 50% pure biosurfactant.

Biosurfactants form an important class of secondary metabolites produced by a variety of microorganisms such as bacteria, fungi, and yeasts. As amphiphilic molecules, microbial biosurfactants reduce the surface and interfacial tensions between the molecules of liquids, solids, and gases. Furthermore, the biosurfactants according to the subject invention are biodegradable, have low toxicity, are effective in solubilizing and degrading insoluble compounds in soil and can be produced using low cost and renewable resources. They can inhibit adhesion of undesirable microorganisms to a variety of surfaces, prevent the formation of biofilms, and can have powerful emulsifying and demulsifying properties. Furthermore, the biosurfactants can also be used to improve wettability and to achieve even solubilization and/or distribution of fertilizers, nutrients, and water in the soil.

Biosurfactants according to the subject methods can be selected from, for example, low molecular weight glycolipids (e.g., sophorolipids, cellobiose lipids, rhamnolipids, mannosylerythritol lipids and trehalose lipids), lipopeptides (e.g., surfactin, iturin, fengycin, arthrofactin and lichenysin), flavolipids, phospholipids (e.g., cardiolipins), fatty acid esters, and high molecular weight polymers such as lipoproteins, lipopolysaccharide-protein complexes, and polysaccharide-protein-fatty acid complexes.

The composition can comprise one or more biosurfactants at a concentration of 0.001% to 10%, 0.01% to 5%, 0.05% to 2%, and/or from 0.1% to 1% by weight.

The composition can comprise the fermentation medium containing a live and/or an inactive culture, the purified or crude form growth by-products, such as biosurfactants, enzymes, and/or other metabolites, and/or any residual nutrients.

The product of fermentation may be used directly, with or without extraction or purification. If desired, extraction and purification can be easily achieved using standard extraction and/or purification methods or techniques described in the literature.

The microorganisms in the composition may be in an active or inactive form, or in the form of vegetative cells, reproductive spores, mycelia, hyphae, conidia or any other form of microbial propagule. The composition may also contain a combination of any of these microbial forms.

In one embodiment, when a combination of strains of microorganism are included in the composition, the different strains of microbe are grown separately and then mixed together to produce the composition.

Advantageously, in accordance with the subject invention, the composition may comprise the medium in which the microbes were grown. The composition may be, for example, at least, by weight, 1%, 5%, 10%, 25%, 50%, 75%, or 100% growth medium. The amount of biomass in the composition, by weight, may be, for example, anywhere from 0% to 100% inclusive of all percentages therebetween.

In one embodiment, the composition is preferably formulated for application to soil, seeds, whole plants, or plant parts (including, but not limited to, roots, tubers, stems, flowers and leaves). In certain embodiments, the composition is formulated as, for example, liquid, dust, granules, microgranules, pellets, wettable powder, flowable powder, emulsions, microcapsules, oils, or aerosols.

To improve or stabilize the effects of the composition, it can be blended with suitable adjuvants and then used as such or after dilution, if necessary. In preferred embodiments, the composition is formulated as a liquid, a concentrated liquid, or as dry powder or granules that can be mixed with water and other components to form a liquid product. In one embodiment, the composition can comprise glucose (e.g., in the form of molasses), in addition to an osmoticum substance, to ensure optimum osmotic pressure during storage and transport of the dry product.

The compositions can be used either alone or in combination with other compounds and/or methods for efficiently enhancing plant health, growth and/or yields, and/or for supplementing the growth of the microorganisms in the composition. For example, in one embodiment, the composition can include and/or can be applied concurrently with nutrients and/or micronutrients for enhancing plant and/or microbe growth, such as magnesium, phosphate, nitrogen, potassium, selenium, calcium, sulfur, iron, copper, and zinc; and/or one or more prebiotics, such as kelp extract, fulvic acid, chitin, humate and/or humic acid. The exact materials and the quantities thereof can be determined by a grower or an agricultural scientist having the benefit of the subject disclosure.

The compositions can also be used in combination with other agricultural compounds and/or crop management systems. In one embodiment, the composition can optionally comprise, or be applied with, for example, natural and/or chemical pesticides, repellants, herbicides, fertilizers, water treatments, non-ionic surfactants and/or soil amendments. Preferably, however, the composition does not comprise and/or is not used with benomyl, dodecyl dimethyl ammonium chloride, hydrogen dioxide/peroxyacetic acid, imazilil, propiconazole, tebuconazole, or triflumizole.

If the composition is mixed with compatible chemical additives, the chemicals are preferably diluted with water prior to addition of the subject composition.

Further components can be added to the composition, for example, buffering agents, carriers, other microbe-based compositions produced at the same or different facility, viscosity modifiers, preservatives, nutrients for microbe growth, tracking agents, biocides, other microbes, surfactants, emulsifying agents, lubricants, solubility controlling agents, pH adjusting agents, preservatives, stabilizers and ultra-violet light resistant agents.

The pH of the microbe-based composition should be suitable for the microorganism of interest. In a preferred embodiment, the pH of the composition is about 3.5 to 7.0, about 4.0 to 6.5, or about 5.0.

Optionally, the composition can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C.

The microbe-based compositions may be used without further stabilization, preservation, and storage, however. Advantageously, direct usage of these microbe-based compositions preserves a high viability of the microorganisms, reduces the possibility of contamination from foreign agents and undesirable microorganisms, and maintains the activity of the by-products of microbial growth.

In other embodiments, the composition (microbes, growth medium, or microbes and medium) can be placed in containers of appropriate size, taking into consideration, for example, the intended use, the contemplated method of application, the size of the fermentation vessel, and any mode of transportation from microbe growth facility to the location of use. Thus, the containers into which the microbe-based composition is placed may be, for example, from 1 pint to 1,000 gallons or more. In certain embodiments the containers are 1 gallon, 2 gallons, 5 gallons, 25 gallons, or larger.

### Growth of Microbes According to the Subject Invention

The subject invention utilizes methods for cultivation of microorganisms and production of microbial metabolites and/or other by-products of microbial growth. The subject invention further utilizes cultivation processes that are suitable for cultivation of microorganisms and production of microbial metabolites on a desired scale. These cultivation processes include, but are not limited to, submerged cultivation/fermentation, solid state fermentation (SSF), and modifications, hybrids and/or combinations thereof.

As used herein “fermentation” refers to cultivation or growth of cells under controlled conditions. The growth could be aerobic or anaerobic. In preferred embodiments, the microorganisms are grown using SSF and/or modified versions thereof.

In one embodiment, the subject invention provides materials and methods for the production of biomass (e.g., viable cellular material), extracellular metabolites (e.g. small molecules and proteins), residual nutrients and/or intracellular components (e.g. enzymes and other proteins).

The microbe growth vessel used according to the subject invention can be any fermenter or cultivation reactor for industrial use. In one embodiment, the vessel may have functional controls/sensors or may be connected to functional controls/sensors to measure important factors in the cultivation process, such as pH, oxygen, pressure, temperature, humidity, microbial density and/or metabolite concentration.

In a further embodiment, the vessel may also be able to monitor the growth of microorganisms inside the vessel (e.g., measurement of cell number and growth phases).

Alternatively, a daily sample may be taken from the vessel and subjected to enumeration by techniques known in the art, such as dilution plating technique. Dilution plating is a simple technique used to estimate the number of organisms in a sample. The technique can also provide an index by which different environments or treatments can be compared.

In one embodiment, the method includes supplementing the cultivation with a nitrogen source. The nitrogen source can be, for example, potassium nitrate, ammonium nitrate ammonium sulfate, ammonium phosphate, ammonia, urea, and/or ammonium chloride. These nitrogen sources may be used independently or in a combination of two or more.

The method can provide oxygenation to the growing culture. One embodiment utilizes slow motion of air to remove low-oxygen containing air and introduce oxygenated air. In the case of submerged fermentation, the oxygenated air may be ambient air supplemented daily through mechanisms including impellers for mechanical agitation of liquid, and air spargers for supplying bubbles of gas to liquid for dissolution of oxygen into the liquid.

The method can further comprise supplementing the cultivation with a carbon source. The carbon source can be a carbohydrate, such as glucose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, propanol, butanol, pentanol, hexanol, isobutanol, and/or glycerol; fats and oils such as soybean oil, canola oil, rice bran oil, olive oil, corn oil, sunflower oil, sesame oil, and/or linseed oil; etc. These carbon sources may be used independently or in a combination of two or more.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, and microelements can be included, for example, in the form of flours or meals, such as corn flour, or in the form of extracts, such as yeast extract, potato extract, beef extract, soybean extract, banana peel extract, and the like, or in purified forms. Amino acids such as, for example, those useful for biosynthesis of proteins, can also be included.

In one embodiment, inorganic salts may also be included. Usable inorganic salts can be potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, lead chloride, copper sulfate, calcium chloride, sodium chloride, calcium carbonate, and/or sodium carbonate. These inorganic salts may be used independently or in a combination of two or more.

In some embodiments, the method for cultivation may further comprise adding additional acids and/or antimicrobials in the medium before, and/or during the cultivation process. Antimicrobial agents or antibiotics are used for protecting the culture against contamination.

Additionally, antifoaming agents may also be added to prevent the formation and/or accumulation of foam during submerged cultivation.

The pH of the mixture should be suitable for the microorganism of interest. Buffers, and pH regulators, such as carbonates and phosphates, may be used to stabilize pH near a preferred value. When metal ions are present in high concentrations, use of a chelating agent in the medium may be necessary.

The microbes can be grown in planktonic form or as biofilm. In the case of biofilm, the vessel may have within it a substrate upon which the microbes can be grown in a biofilm state. The system may also have, for example, the capacity to apply stimuli (such as shear stress) that encourages and/or improves the biofilm growth characteristics.

In one embodiment, the method for cultivation of microorganisms is carried out at about 5° to about 100° C., preferably, 15 to 60° C., more preferably, 25 to 50° C. In a further embodiment, the cultivation may be carried out continuously at a constant temperature. In another embodiment, the cultivation may be subject to changing temperatures.

In one embodiment, the equipment used in the method and cultivation process is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the medium may be pasteurized or, optionally, no heat at all added, where the use of low water activity and low pH may be exploited to control undesirable bacterial growth.

In one embodiment, the subject invention further provides a method for producing microbial metabolites such as, for example, biosurfactants, enzymes, proteins, ethanol, lactic acid, beta-glucan, peptides, metabolic intermediates, polyunsaturated fatty acid, and lipids, by cultivating a microbe strain of the subject invention under conditions appropriate for growth and metabolite production; and, optionally, purifying the metabolite. The metabolite content produced by the method can be, for example, at least 20%, 30%, 40%, 50%, 60%, 70%, 80%, or 90%.

The microbial growth by-product produced by microorganisms of interest may be retained in the microorganisms or secreted into the growth medium. The medium may contain compounds that stabilize the activity of microbial growth by-product.

The biomass content of the fermentation medium may be, for example, from 5 g/l to 180 g/l or more, or from 10 g/l to 150 g/l.

The cell concentration may be, for example, at least 1×10⁶ to 1×10¹³, 1×10⁷ to 1×10¹², 1×10⁸ to 1×10¹¹, or 1×10⁹ to 1×10¹⁰ CFU/ml.

The method and equipment for cultivation of microorganisms and production of the microbial by-products can be performed in a batch, a quasi-continuous process, or a continuous process.

In one embodiment, all of the microbial cultivation composition is removed upon the completion of the cultivation (e.g., upon, for example, achieving a desired cell density, or density of a specified metabolite). In this batch procedure, an entirely new batch is initiated upon harvesting of the first batch.

In another embodiment, only a portion of the fermentation product is removed at any one time. In this embodiment, biomass with viable cells, spores, conidia, hyphae and/or mycelia remains in the vessel as an inoculant for a new cultivation batch. The composition that is removed can be a cell-free medium or contain cells, spores, or other reproductive propagules, and/or a combination of thereof. In this manner, a quasi-continuous system is created.

Advantageously, the method does not require complicated equipment or high energy consumption. The microorganisms of interest can be cultivated at small or large scale on site and utilized, even being still-mixed with their media.

Advantageously, the microbe-based products can be produced in remote locations. The microbe growth facilities may operate off the grid by utilizing, for example, solar, wind and/or hydroelectric power.

### Microbial Strains

The microorganisms useful according to the subject invention can be, for example, non-plant-pathogenic strains of bacteria, yeast and/or fungi. These microorganisms may be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In one embodiment, the microorganism is a yeast or fungus. Yeast and fungus species suitable for use according to the current invention, include Aureobasidium (e.g., A. pullulans), Blakeslea, Candida (e.g., C. apicola, C. bombicola, C. nodaensis), Cryptococcus, Debaryomyces (e.g., D. hansenii), Entomophthora, Hanseniaspora, (e.g., H. uvarum), Hansenula, Issatchenkia, Kluyveromyces (e.g., K. phaffii), Lentinula edodes, Mortierella, Mycorrhiza, Meyerozyma (M. guilliermondii), Penicillium, Phycomyces, Pichia (e.g., P. anomala, P. guilliermondii, P. occidentalis, P. kudriavzevii), Pleurotus spp. (e.g., P. ostreatus), Pseudozyma (e.g., P. aphidis), Saccharomyces (e.g., S. boulardii sequela, S. cerevisiae, S. torula), Starmerella (e.g., S. bombicola), Torulopsis, Trichoderma (e.g., T. reesei, T. harzianum, T. hamatum, T. viride), Ustilago (e.g., U. maydis), Wickerhamomyces (e.g., W. anomalus), Williopsis (e.g., W. mrakii), Zygosaccharomyces (e.g., Z. bailii), and others.

In an exemplary embodiment, the subject invention utilizes killer yeasts, which are yeasts that can produce enzymes and other compounds that are toxic to other microbial species. Preferably, these yeasts are capable of colonizing a plant's roots at the root-soil interface, and providing a number of benefits to the rhizosphere. Even more specifically, the killers yeasts include Wickerhamomyces anomalus (Pichia anomala). Other closely related species are also envisioned, e.g., other members of the Wickerhamomyces and/or Pichia clades. W. anomalus have a number of beneficial characteristics useful for the present invention, including their ability to produce advantageous metabolites. For example, W. anomalus is capable of exo-β-1,3-glucanase activity, making it capable of controlling or inhibiting the growth of a wide spectrum of microbes, including methanogens. Additionally, if cultivated for 5-7 days, W. anomalus produces biosurfactants that are capable of reducing surface/interfacial tension of water, as well as exhibiting antimicrobial and antifungal properties.

In addition to various by-products, these yeasts are capable of producing phytase and providing a number of proteins (containing up to 50% of dry cell biomass), lipids and carbon sources, as well as a full spectrum of minerals and vitamins (B1; B2; B3 (PP); B5; B7 (H); B6; E).

In certain embodiments, the microorganism can be another yeast, such as Starmerella bombicola, Saccharomyces boulardii, Pseudozyma aphidis and/or a Pichia yeast (e.g., Pichia occidentalis, Pichia kudrimzevii and/or Pichia guilliernmondii (Meyerozyma guilliermondii)).

In one embodiment, the microorganism can be a fungus, such as Lentinula edodes, Pleurotus ostreatus, or a Trichoderma spp. fungus (e.g., T. harzianum, T. viride, T. hamatum, and/or T. reesei).

In certain embodiments, the microorganisms are bacteria, including Gram-positive and Gram-negative bacteria. The bacteria may be, for example Agrobacterium (e.g., A. radiobacter), Azotobacter (A. vinelandii, A. chroococcum), Azospirillum (e.g., A. brasiliensis), Bacillus (e.g., B. amyloliquefaciens, B. circulans, B. firmus, B. laterosporus, B. licheniformis, B. megaterium, Bacillus mucilaginosus, B. subtilis), Frateuria (e.g., F. aurantia), Microbacterium (e.g., M. laevaniformans), myxobacteria (e.g., Myxococcus xanthus, Stignatella aurantiaca, Sorangium cellulosum, Minicystis rosea), Paenibacillus polymyxa, Pantoea (e.g., P. agglomerans), Pseudomonas (e.g., P. aeruginosa, P. chlororaphis subsp. aureofaciens (Kluyver), P. putida), Rhizobium spp., Rhodospirillum (e.g., R. rubrum), Sphingomonas (e.g., S. paucimobilis), and/or Thiobacillus thiooxidans (Acidothiobacillus thiooxidans).

In one embodiment, the microorganism is bacteria, such as Pseudomonas chlororaphis, or a Bacillus spp. bacterium, such as, for example, B. subtilis and/or B. amyloliquefaciens (e.g., B. amyloliquefaciens subsp. locus). Advantageously, in particular, B. amyloliquefaciens is capable of lowering the pH of soils and solubilizing nutrients, such as those in NPK fertilizers, to be more readily available for plant root uptake. In some instances, B. amyloliquefaciens can also fix atmospheric nitrogen and reduce nitrogen to ammonia.

In one embodiment, the microorganism is a myxobacterium, or slime-forming bacteria. Specifically, in one embodiment, the myxobacterium is a Myxococcus spp. bacterium, e.g., M. xanthus.

In certain embodiments, the microorganism is one that is capable of fixing and/or solubilizing nitrogen, potassium, phosphorous and/or other micronutrients in soil.

In one embodiment, the microorganism is a nitrogen-fixing microorganism, or a diazotroph, selected from species of, for example, Azospirillum, Azotobacter, Chlorobiaceae, Cyanothece, Frankia, Klebsiella, rhizobia, Trichodesmium, and some Archaea. In a specific embodiment, the nitrogen-fixing bacteria is Azotobacter vinelandii.

In one embodiment, the microorganism is a potassium-mobilizing microorganism, or KMB, selected from, for example, Bacillus mucilaginosus, Frateuria aurantia or Gilomus mosseae. In a specific embodiment, the potassium-mobilizing microorganism is Frateuria aurantia.

In one embodiment, the microorganism is a non-denitrifying microorganism capable of converting nitrous oxide from the atmosphere into nitrogen in the soil, such as, for example, Dyadobacter fermenters.

In one embodiment, a combination of microorganisms is used in the subject microbe-based composition, wherein the microorganisms work synergistically with one another to enhance plant biomass, and/or to enhance the properties of the rhizosphere.

### Preparation of Microbe-Based Products

One microbe-based product of the subject invention is simply the fermentation medium containing the microorganisms and/or the microbial metabolites produced by the microorganisms and/or any residual nutrients. The product of fermentation may be used directly without extraction or purification. If desired, extraction and purification can be easily achieved using standard extraction and/or purification methods or techniques described in the literature.

The microorganisms in the microbe-based products may be in an active or inactive form, or in the form of vegetative cells, reproductive spores, conidia, mycelia, hyphae, or any other form of microbial propagule. The microbe-based products may also contain a combination of any of these forms of a microorganism.

In one embodiment, different strains of microbe are grown separately and then mixed together to produce the microbe-based product. The microbes can, optionally, be blended with the medium in which they are grown and dried prior to mixing.

In one embodiment, the different strains are not mixed together, but are applied to a plant and/or its environment as separate microbe-based products.

The microbe-based products may be used without further stabilization, preservation, and storage. Advantageously, direct usage of these microbe-based products preserves a high viability of the microorganisms, reduces the possibility of contamination from foreign agents and undesirable microorganisms, and maintains the activity of the by-products of microbial growth.

Upon harvesting the microbe-based composition from the growth vessels, further components can be added as the harvested product is placed into containers or otherwise transported for use. The additives can be, for example, buffers, carriers, other microbe-based compositions produced at the same or different facility, viscosity modifiers, preservatives, nutrients for microbe growth, surfactants, emulsifying agents, lubricants, solubility controlling agents, tracking agents, solvents, biocides, antibiotics, pH adjusting agents, chelators, stabilizers, ultra-violet light resistant agents, other microbes and other suitable additives that are customarily used for such preparations.

In one embodiment, buffering agents including organic and amino acids or their salts, can be added. Suitable buffers include citrate, gluconate, tartarate, malate, acetate, lactate, oxalate, aspartate, malonate, glucoheptonate, pyruvate, galactarate, glucarate, tartronate, glutamate, glycine, lysine, glutamine, methionine, cysteine, arginine and a mixture thereof. Phosphoric and phosphorous acids or their salts may also be used. Synthetic buffers are suitable to be used but it is preferable to use natural buffers such as organic and amino acids or their salts listed above.

In a further embodiment, pH adjusting agents include potassium hydroxide, ammonium hydroxide, potassium carbonate or bicarbonate, hydrochloric acid, nitric acid, sulfuric acid or a mixture.

The pH of the microbe-based composition should be suitable for the microorganism(s) of interest. In a preferred embodiment, the pH of the composition is about 3.5 to 7.0, about 4.0 to 6.5, or about 5.0.

In one embodiment, additional components such as an aqueous preparation of a salt, such as sodium bicarbonate or carbonate, sodium sulfate, sodium phosphate, sodium biphosphate, can be included in the formulation.

In certain embodiments, an adherent substance can be added to the composition to prolong the adherence of the product to plant parts. Polymers, such as charged polymers, or polysaccharide-based substances can be used, for example, xanthan gum, guar gum, levan, xylinan, gellan gum, curdlan, pullulan, dextran and others.

In preferred embodiments, commercial grade xanthan gum is used as the adherent. The concentration of the gum should be selected based on the content of the gum in the commercial product. If the xanthan gum is highly pure, then 0.001% (w/v—xanthan gum/solution) is sufficient.

In one embodiment, glucose, glycerol and/or glycerin can be added to the microbe-based product to serve as, for example, an osmoticum during storage and transport. In one embodiment, molasses can be included.

In one embodiment, prebiotics can be added to and/or applied concurrently with the microbe-based product to enhance microbial growth. Suitable prebiotics, include, for example, kelp extract, fulvic acid, chitin, humate and/or humic acid. In a specific embodiment, the amount of prebiotics applied is about 0.1 L/acre to about 0.5 L/acre, or about 0.2 L/acre to about 0.4 L/acre.

In one embodiment, specific nutrients are added to and/or applied concurrently with the microbe-based product to enhance microbial inoculation and growth. These can include, for example, soluble potash (K₂O), magnesium, sulfur, boron, iron, manganese, and/or zinc. The nutrients can be derived from, for example, potassium hydroxide, magnesium sulfate, boric acid, ferrous sulfate, manganese sulfate, and/or zinc sulfate.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C.

### Local Production of Microbe-Based Products

In certain embodiments of the subject invention, a microbe growth facility produces fresh, high-density microorganisms and/or microbial growth by-products of interest on a desired scale. The microbe growth facility may be located at or near the site of application. The facility produces high-density microbe-based compositions in batch, quasi-continuous, or continuous cultivation.

The microbe growth facilities of the subject invention can be located at the location where the microbe-based product will be used (e.g., a citrus grove). For example, the microbe growth facility may be less than 300, 250, 200, 150, 100, 75, 50, 25, 15, 10, 5, 3, or 1 mile from the location of use.

Because the microbe-based product can be generated locally, without resort to the microorganism stabilization, preservation, storage and transportation processes of conventional microbial production, a much higher density of microorganisms can be generated, thereby requiring a smaller volume of the microbe-based product for use in the on-site application or which allows much higher density microbial applications where necessary to achieve the desired efficacy. This allows for a scaled-down bioreactor (e.g., smaller fermentation vessel, smaller supplies of starter material, nutrients and pH control agents), which makes the system efficient and can eliminate the need to stabilize cells or separate them from their culture medium. Local generation of the microbe-based product also facilitates the inclusion of the growth medium in the product. The medium can contain agents produced during the fermentation that are particularly well-suited for local use.

Locally-produced high density, robust cultures of microbes are more effective in the field than those that have remained in the supply chain for some time. The microbe-based products of the subject invention are particularly advantageous compared to traditional products wherein cells have been separated from metabolites and nutrients present in the fermentation growth media. Reduced transportation times allow for the production and delivery of fresh batches of microbes and/or their metabolites at the time and volume as required by local demand.

The microbe growth facilities of the subject invention produce fresh, microbe-based compositions, comprising the microbes themselves, microbial metabolites, and/or other components of the medium in which the microbes are grown. If desired, the compositions can have a high density of vegetative cells or propagules, or a mixture of vegetative cells and propagules.

In one embodiment, the microbe growth facility is located on, or near, a site where the microbe-based products will be used (e.g., a citrus grove), for example, within 300 miles, 200 miles, or even within 100 miles. Advantageously, this allows for the compositions to be tailored for use at a specified location. The formula and potency of microbe-based compositions can be customized for specific local conditions at the time of application, such as, for example, which soil type, plant and/or crop is being treated; what season, climate and/or time of year it is when a composition is being applied; and what mode and/or rate of application is being utilized.

Advantageously, distributed microbe growth facilities provide a solution to the current problem of relying on far-flung industrial-sized producers whose product quality suffers due to upstream processing delays, supply chain bottlenecks, improper storage, and other contingencies that inhibit the timely delivery and application of, for example, a viable, high cell-count product and the associated medium and metabolites in which the cells are originally grown.

Furthermore, by producing a composition locally, the formulation and potency can be adjusted in real time to a specific location and the conditions present at the time of application. This provides advantages over compositions that are pre-made in a central location and have, for example, set ratios and formulations that may not be optimal for a given location.

The microbe growth facilities provide manufacturing versatility by their ability to tailor the microbe-based products to improve synergies with destination geographies. Advantageously, in preferred embodiments, the systems of the subject invention harness the power of naturally-occurring local microorganisms and their metabolic by-products to improve GHG management.

The cultivation time for the individual vessels may be, for example, from 1 to 7 days or longer. The cultivation product can be harvested in any of a number of different ways.

Local production and delivery within, for example, 24 hours of fermentation results in pure, high cell density compositions and substantially lower shipping costs. Given the prospects for rapid advancement in the development of more effective and powerful microbial inoculants, consumers will benefit greatly from this ability to rapidly deliver microbe-based products.

### EXAMPLES

A greater understanding of the present invention and of its many advantages may be had from the following examples, given by way of illustration. The following examples are illustrative of some of the methods, applications, embodiments and variants of the present invention. They are not to be considered as limiting the invention. Numerous changes and modifications can be made with respect to the invention.

### Example 1—Microbe-Based Composition

Exemplified herein is a composition according to certain embodiments of subject invention for use in reducing GHGs, improving carbon utilization, and/or enhancing sequestration of carbon. This example is not to be intended as limiting. Formulations comprising other species of microorganisms, either in lieu of, or in addition to, those exemplified here, may be included in the composition.

The composition comprises a microbial inoculant comprising a Trichoderma spp. fungus and a Bacillus spp. bacterium. In specific instances, the composition comprises Trichoderma harzianum and Bacillus amyloliquefaciens. Even more specifically, the strain of B. amyloliquefaciens can be B. amyloliquefaciens subsp. locus.

In one embodiment, the composition can comprise from 1 to 99% Trichoderma by weight and from 99 to 1% Bacillus by weight. In some embodiments, the cell count ratio of Trichoderma to Bacillus is about 1:9 to about 9:1, about 1:8 to about 8:1, about 1:7 to about 7:1, about 1:6 to about 6:1, about 1:5 to about 5:1 or about 1:4 to about 4:1.

The composition can comprise about 1×10⁶ to 1×10¹², 1×10⁷ to 1×10¹¹, 1×10⁸ to 1×10¹⁰, or 1×10⁹ CFU/ml of the Trichoderma; and about 1×10⁶ to 1×10¹², 1×10⁷ to 1×10¹¹, 1×10⁸ to 1×10¹⁰, or 1×10⁹ CFU/ml of the Bacillus.

The composition can be mixed with and/or applied concurrently with additional “starter” materials to promote initial growth of the microorganisms in the composition. These can include, for example, prebiotics and/or nano-fertilizers (e.g., Aqua-Yield, NanoGro™).

One exemplary formulation of such growth-promoting “starter” materials comprises:
Soluble potash (K₂O) (1.0% to 2.5%, or about 2.0%)
Magnesium (Mg) (0.25% to 0.75%, or about 0.5%)
Sulfur (S) (2.5% to 3.0%, or about 2.7%)
Boron (B) (0.01% to 0.05%, or about 0.02%)
Iron (Fe) (0.25% to 0.75%, or about 0.5%)
Manganese (Mn) (0.25% to 0.75%, or about 0.5%)
Zinc (Zn) (0.25% to 0.75%, or about 0.5%)
Humic acid (8% to 12%, or about 10%)
Kelp extract (5% to 10%, or about 6%)
Water (70% to 85%, or about 77% to 80%)

The microbial inoculant, and/or optional growth-promoting “starter” materials, are mixed with water in an irrigation system tank and applied to soil.

In specific instances, the composition comprises 10.0% by weight of the microbial inoculant, and 90% by weight water, where the inoculant comprises 1×10⁸ CFU/mL Trichoderma harzianum and 1×10⁹ CFU/mL of Bacillus amyloliquefaciens.

### Example 2—Increase in Below-Ground Biomass of Citrus Trees (Root Mass)

A composition comprising Trichoderma harzianum and Bacillus amyloliquefaciens was applied three times, bi-monthly, to soil in which orange trees and grapefruit trees were growing. Root mass was measured before and after treatment and compared with untreated control trees (“Grower's Practice”).

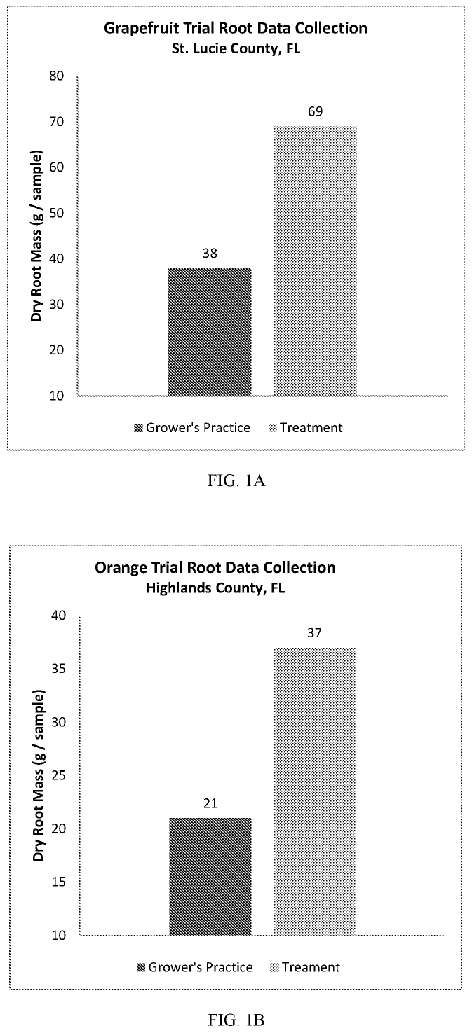

As shown in FIGS. 1A-1B, a statistically significant difference in fibrous root biomass was achieved between untreated control trees and treated trees.

### Example 3—Increase in Above-Ground Biomass of Citrus Trees (Canopy Density)

A composition comprising Trichoderma harzianum and Bacillus amyloliquefaciens was applied three times, bi-monthly, to soil in which mature orange trees and young orange trees were growing. Canopy density rating was measured before and after treatment and the increase was compared with untreated control trees (“Grower's Practice”).

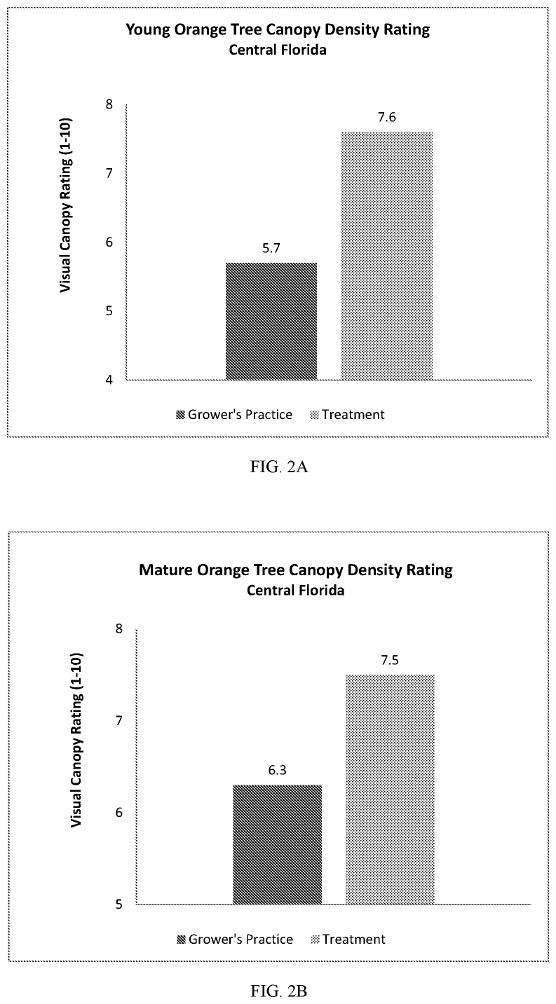

As shown in FIGS. 2A-2B, a greater canopy density rating was achieved for both mature and young orange trees when compared to the rating observed in untreated control trees of the same age.

### Example 4—Increase in Above-Ground Biomass of Almond Trees (Caliper)

A composition comprising Trichoderma harzianum and Bacillus amyloliquefaciens was applied two times, bi-monthly, to soil in which almond trees were growing. Trunk caliper (diameter) was measured before and after treatment and compared with untreated control trees (“Grower's Practice”).

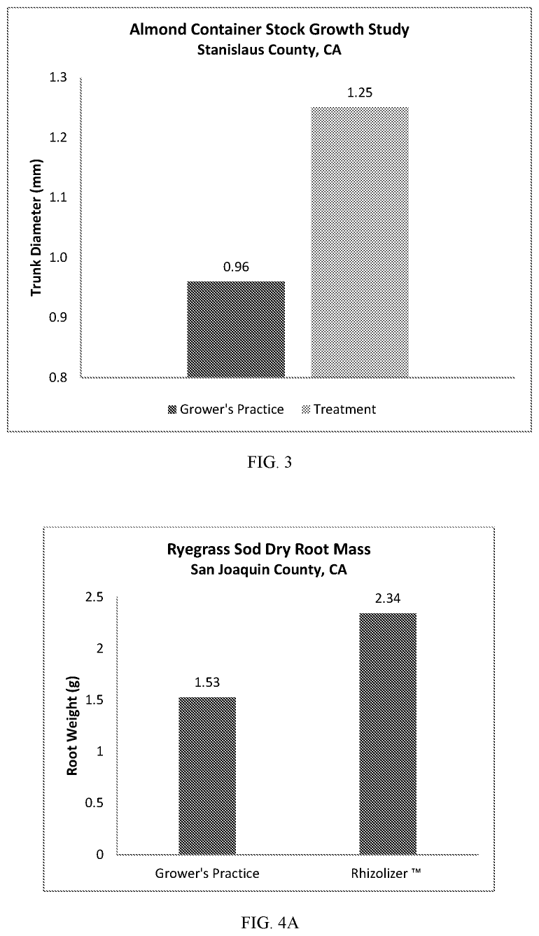

As shown in FIG. 3, a statistically significant difference in caliper measurement (about 30%) between treated and untreated trees was achieved.

### Example 5—Increase in Below-Ground Biomass of Sod (Root Mass)

A composition comprising Trichoderma harzianum and Bacillus amyloliquefaciens was applied three times, semi-monthly, to soils in which ryegrass sod and blue rye sod were growing. Dry root mass was measured before and after treatment and compared with untreated control sods (“Grower's Practice”).

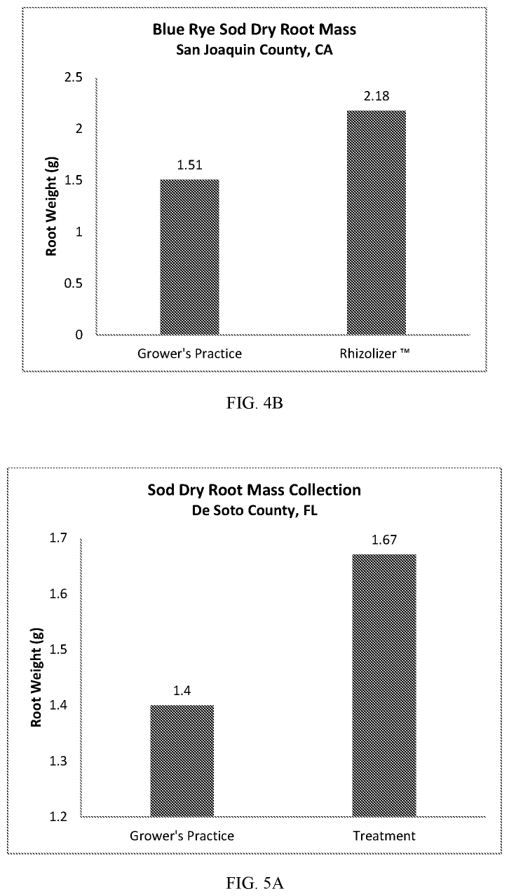

As shown in FIGS. 4A-4B, a statistically significant difference in dry root mass between treated and untreated ryegrass (about 35%), and between treated and untreated blue rye (about 31%) was achieved.

### Example 6—Increase in Root Biomass and Chlorophyll Rating of Sod

A composition comprising Trichoderma harzianum and Bacillus amyloliquefaciens was applied three times, bi-monthly, to soils in which sod grass was growing. Dry root mass and chlorophyll rating (relative greenness) were measured before and after treatment and compared with untreated control sods (“Grower's Practice”).

As shown in FIGS. 5A-5B, an increase in dry root mass and in chlorophyll rating was achieved for sod grass when compared to untreated control sod.

### Example 7—Increase in Chlorophyll, Leaf Length and Leaf Width of Tobacco

A composition comprising Trichoderma harzianum and Bacillus amyloliquefaciens was applied 1 time to soils in which tobacco plants were transplanted. Average chlorophyll rating (relative greenness), leaf length and leaf width were measured before and after treatment and compared with untreated control tobacco plants (“Grower's Practice”).

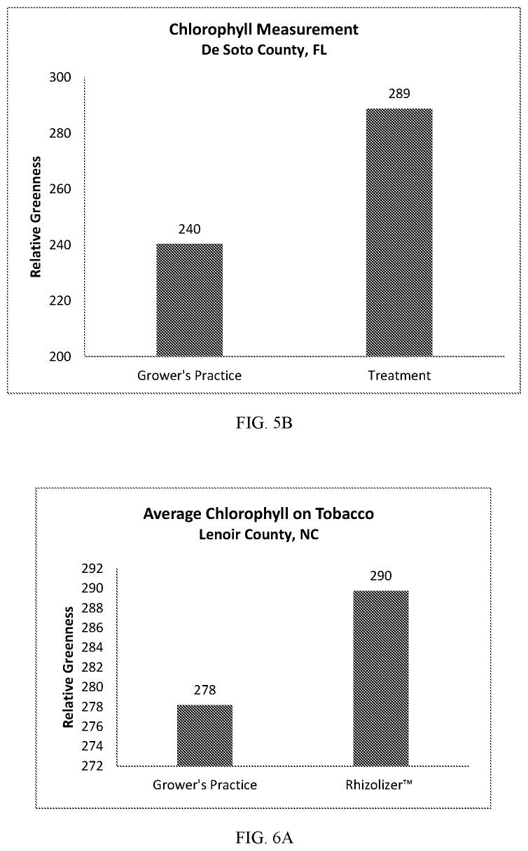

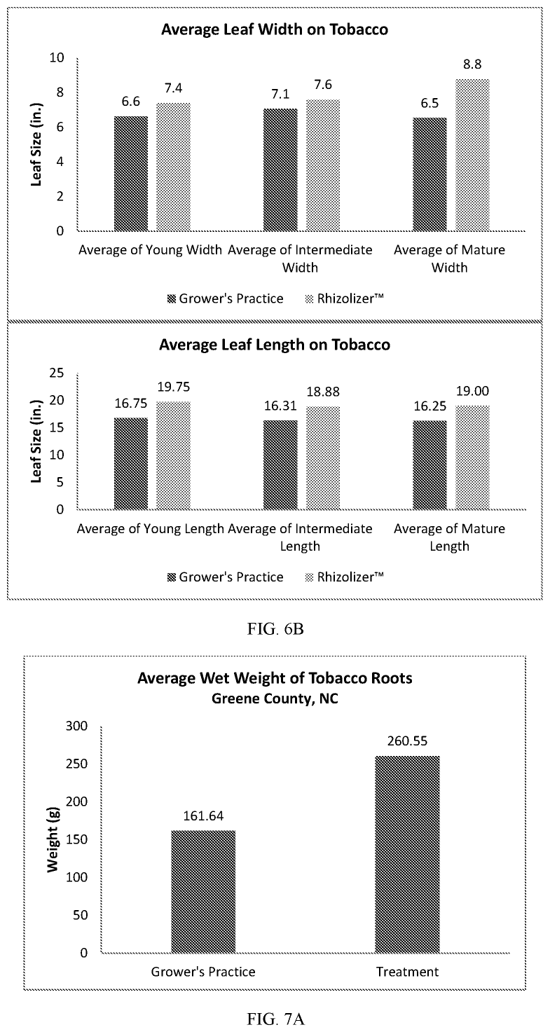

As shown in FIGS. 6A-6B, the treated tobacco plants exhibited a 4% higher chlorophyll content (6A), a 16 to 18% increased leaf length and 7 to 35% increased leaf width (6B), compared to grower's practice.

### Example 8—Enhanced Root Development in Tobacco Plants

A composition comprising Trichoderma harzianum and Bacillus amyloliquefaciens was applied two times to soils in which tobacco plants were transplanted (the first upon setting, and the second 30 days thereafter). Average wet root weight and average size (length and width) of roots was measured before and after treatment and compared with untreated control tobacco plants (“Grower's Practice”).

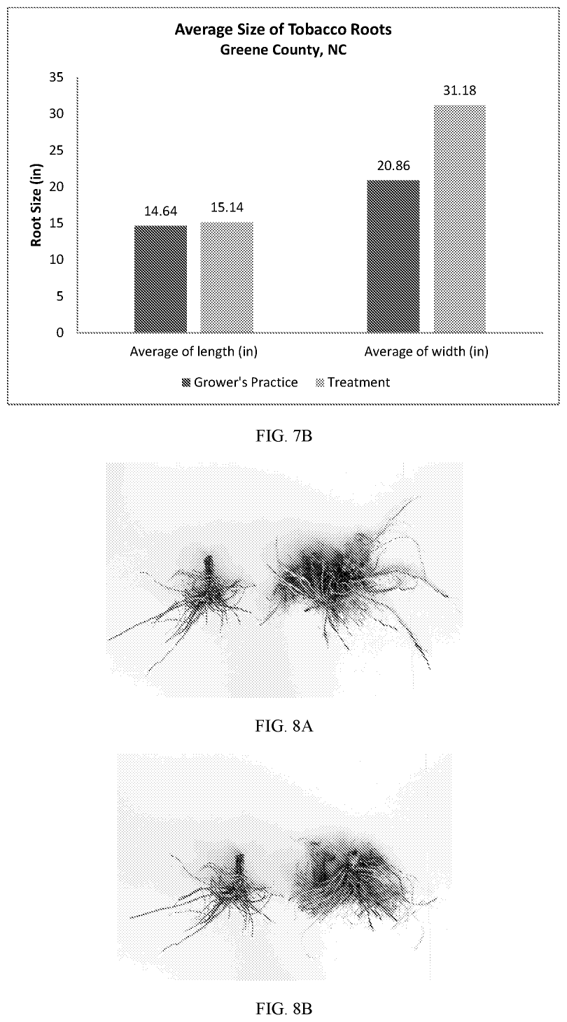

As shown in FIGS. 7A-7B, the treated tobacco plants exhibited a 61% increase in fibrous root wet mass (7A), as well as up to a 49% increase in root length and 3% increase in root width (7B), compared to grower's practice.

As shown in FIG. 8A, the wet root mass (8A) and the density of root fibers (8B) of untreated plants (left) was visibly smaller than that of the treated plants (right).

### Example 9—Greenhouse Gas Emissions and Carbon Sequestration Sampling Protocol

To determine the capabilities of the subject invention for mitigating GHG emissions, and the ability of soils treated according to the subject invention to sequester carbon and nitrogen, agricultural soils treated with a composition prepared according to embodiments of the subject invention are compared with grower's practice control soils, as well as to native, uncultivated soils.

The work is performed in citrus groves comprising mature and young Florida citrus trees treated for approximately 1 year with the composition; and California table grapes treated for approximately 6 months with the composition. Sampling locations are determined to provide a comparison between treated soils and grower's practice soils. Control and treatment locations are monitored under the same conditions, with the treatment locations being treated with a soil amendment comprising a composition as prepared in Example 1.

All sampling locations for each crop type are in adjacent blocks, thus limiting the variability between soil type, geography, and crop type. In addition, native soils that are adjacent to both the treated and control soils are tested to determine the background emissions of the native soil without agricultural practices applied.

Flux measurements (CO2, N2O, CH4)

A Gasmet DX-4040 portable FTIR (Fourier Transform Infrared) multi-gas analyzer integrated with a Li-Cor 8100-103 20-cm survey chamber is employed to measure CO₂, N₂O, CH₄, and NH₄ flux rates from the soil. Before sampling, collars are installed at the soil surface at each location and allowed a minimum of three hours for the soils to equilibrate back to its original state after the disturbance. Flux rates are calculated by fitting a linear regression to gas concentrations versus sampling time.

### Soil Samples

Soil samples are collected with a ⅞×21 inch soil sample probe. At each location, a circle with an approximately 2-foot radius is measured out around the flux measurement soil collar and 12 soil samples are collected along the circumference of the circle at approximately equal distances from one another.

Each individual soil sample is collected to a depth of 6 inches. Ten of the samples are collected in a brown paper bag and aggregated together in order to make a homogenous sample at each location. These samples are analyzed for: organic carbon, total nitrogen, permanganate oxidizable carbon, pH and three-day microbial respiration. The other two soil samples are placed in individual plastic bags and are analyzed for bulk density.

### Soil Measurements

A POGO Soil Moisture sensor is used to measure soil temperature, moisture content and bulk electrical conductivity of the soil at each sampling location.

### Results

Samples were collected from four locations: three citrus groves in Florida and one table grapery in California. At these sampling sites, the treated soils exhibited up to a 4.38 metric ton CO₂e/acre (2.94 Mg/ha) increase in soil organic carbon for citrus and up to a 3.53 metric ton CO₂e/acre (2.37 Mg/ha) increase for the grapes.

### GHG Emissions

At one of the citrus sites, a reduction of 2.53 metric tons CO₂—C acre-yr⁻¹ was observed. CO₂ contributed 1.29 metric ton CO₂—C acre-yr⁻¹ and N₂O contributed 1.04 metric ton CO₂—C acre-yr⁻¹.

### Example 10—Soil Carbon Measurements for Two Florida Citrus Groves

### Grove 1

The soil of four citrus plots comprising mature orange trees were tested for bulk density and total organic carbon levels after a 10 month growing period. One plot was grown according to standard grower's practice (control). The other three plots were treated with a composition according to embodiments of the subject invention, as shown in Table 1 below.

TABLE 1
Treatment by plot - citrus grove 1.

| Plot | | Application Rate | Application | |
|---|---|---|---|---|
| Number | Treatment composition | (vol./acre) | Frequency | Acres |
| 1 | Standard Grower's Practice | N/A | N/A | 30 acres |
| | (UTC) | | | |
| 2 | Th/Ba + | 3 fl. oz./acre | 5 applications (3 in | 67 acres |
| | NanoGro ™ (applications 1-2) | 5 fl. oz./acre | the spring and 2 in the | |
| | or Kelp/Humic acid mixture | 6.4 fl. oz./acre | fall) | |
| | (applications 3-5) | | | |
| 3 | Th/Ba + | 3 fl. oz./acre | 5 applications (3 in | 29 acres |
| | NanoGro ™ (applications 1-2) | 5 fl. oz./acre | the spring and 2 in the | |
| | or Kelp/Humic acid mixture | 6.4 fl. oz./acre | fall) | |
| | (applications 3-5) | | | |
| 4 | Th/Ba + | 3 fl. oz./acre | 5 applications (3 in | 35 acres |
| | Kelp/Humic acid mixture | 6.4 fl. oz./acre | the spring and 2 in the | |
| | | | fall) | |

Th/Ba = Trichoderma harzianum/Bacillus amyloliquefaciens

Irrigation of each plot occurred for 15 minutes prior to the application of the composition. The composition was mixed into an injection rig and pumped into the irrigation system, followed by a 30 minute flush directly after the application.

The plots were sampled and analyzed, and the results are reported below in Table 2 and Table 3.

TABLE 2
Bulk Density and Total Organic Carbon measurements - citrus grove 1.

| | Bulk Density | Carbon | BD | BD | OC | OC |
|---|---|---|---|---|---|---|
| Sample | (g/100 cc) | (TOC) % | (g/cm³) | (kg/ha) | (g/kg) | (Mg/ha) |
| Grower's | 115 | 0.43 | 1.15 | 1,725,000 | 4.3 | 7.4175 |
| Practice | | | | | | |
| Grower's | 85 | 0.05 | 0.85 | 1,275,000 | 0.5 | 0.6375 |
| Practice | | | | | | |
| Grower's | 96 | 0.48 | 0.96 | 1,440,000 | 4.8 | 6.912 |
| Practice | | | | | | |
| Treated | 84 | 0.24 | 0.84 | 1,260,000 | 2.4 | 3.024 |
| Treated | 93 | 0.53 | 0.93 | 1,395,000 | 5.3 | 7.3935 |
| Treated | 99 | 0.64 | 0.99 | 1,485,000 | 6.4 | 9.504 |

TABLE 3
Average Soil Carbon Increase - citrus grove 1.

| | | | metric tons- |
|---|---|---|---|
| | | | CO2e/acre |
| | Average Soil | | (Emissions |
| | OC (Mg/ha) | tons-C/acre | Prevented) |
| Treated | 6.64 | 2.96 | 9.88 |
| Grower's Practice | 4.99 | 2.23 | 7.43 |
| Soil Organic Carbon | 1.65 | 0.74 | 2.46 |
| Increase | | | |

### Grove 2

The soil of four citrus plots comprising mature orange trees were tested for bulk density and total organic carbon levels after a 10 month growing period. Two plots were grown according to standard grower's practice (control). The other two plots were treated with a composition according to embodiments of the subject invention, as shown in Table 4 below.

TABLE 4
Treatment by plot - citrus grove 2.

| Plot | | Application Rate | Application | |
|---|---|---|---|---|
| Number | Treatment composition | (vol./acre) | Frequency | Acres |
| 1 | Standard Grower's Practice | N/A | N/A | 107.6 |
| | (UTC) | | | |
| 2 | Standard Grower's Practice | N/A | N/A | 137.6 |
| | (UTC) | | | |
| 3 | Th/Ba + | 3 fl. oz./acre | 5 applications (3 in | 145.5 |
| | Kelp/Humic acid mixture | 6.4 fl. oz./acre | the spring and 2 in the | |
| | | | fall) | |
| 4 | Th/Ba + | 3 fl. oz./acre | 5 applications (3 in | 131 |
| | Kelp/Humic acid mixture | 6.4 fl. oz./acre | the spring and 2 in the | |
| | | | fall) | |

Th/Ba = Trichoderma harzianum/Bacillus amyloliquefaciens

Irrigation of each plot occurred for 15 minutes prior to the application of the composition. The composition was mixed into an injection rig and pumped into the irrigation system, followed by a 30 minute flush directly after the application.

The plots were sampled and analyzed. Results are reported below in Tables 5 and 6.

TABLE 5
Bulk Density and Total Organic Carbon measurements - citrus grove 2.

| | Bulk Density | Carbon | BD | BD | OC | OC |
|---|---|---|---|---|---|---|
| Sample | (g/100 cc) | (TOC) % | (g/cm³) | (kg/ha) | (g/kg) | (Mg/ha) |
| Grower's | 82 | 0.19 | 0.82 | 1,230,000 | 1.9 | 2.337 |
| Practice | | | | | | |
| Grower's | 98 | 0.55 | 0.98 | 1,470,000 | 5.5 | 8.085 |
| Practice | | | | | | |
| Grower's | 94 | 0.52 | 0.94 | 1,410,000 | 5.2 | 7.332 |
| Practice | | | | | | |
| Treated | 96 | 0.38 | 0.96 | 1,440,000 | 3.8 | 5.472 |
| Treated | 87 | 0.37 | 0.87 | 1,305,000 | 3.7 | 4.8285 |
| Treated | 94 | 0.76 | 0.94 | 1,410,000 | 7.6 | 10.716 |

TABLE 6
Average Soil Carbon Increase - citrus grove 2

| | | | metric tons- |
|---|---|---|---|
| | | | CO2e/acre |
| | Average Sod | | (Emissions |
| | OC (Mg/ha) | tons-C/acre | Prevented) |
| Treated | 7.01 | 3.13 | 10.43 |
| Grower's Practice | 5.92 | 2.64 | 8.81 |
| Soil Organic Carbon | 1.09 | 0.49 | 1.62 |
| Increase | | | |

### Example 11—Soil Carbon Data—Multiple Crops

Surface soil samples were collected from treated and control plots growing a variety of crops in three different states. Specifically, the crops included almonds, cherries, and grapes from three separate farms in California and sod farms in Arizona, California, and North Carolina.

The soil samples were analyzed for bulk density and total organic carbon (TOC) to determine whether soils from plots treated with the composition for less than a single growing season demonstrated greater organic carbon storage than in adjacent control plots growing the same crops. The data show treated soils having higher organic carbon content than soils from control plots.

A composition according to the subject invention, comprising Trichoderma harzianum and Bacillus amyloliquefaciens, is mixed with water and distributed through an irrigation system with micro-sprinklers or drip irrigation at the base of each crop. For sod, a spray boom is used, followed by overhead irrigation.

Side-by-side comparisons of treatment plots to adjacent, untreated plots of the same crop status and practices were conducted. Following application of two to three treatments, surface soil samples (i.e., top 6 or 12 inches) were collected from multiple locations within treated plots and in adjacent untreated plots. The soil samples were analyzed for TOC and bulk density for quantifying the total carbon content of the soil on an area basis (e.g., per acre).

The soil samples analyzed for TOC were composites of 10 individual soil samples collected within an approximately 5-foot diameter circle of each other. The bulk density sample was a composite of two additional soil samples collected from within the same sampling area.

All samples were collected within the first growing season that the treatment was applied. All plots had two to three treatments with the composition before the soil samples were collected and the total time since first treatment ranged from approximately 3 to 11 months. Three to five replicate surface soil samples were collected from each plot (see Table 7 below).

TABLE 7
Sites and numbers of replicates analyzed for
soil carbon in treated and untreated plots

| | | Sample | Months Since | | Numbers of Replicates | |
|---|---|---|---|---|---|---|
| | | Depth | Numbers | First | Growers | |
| Crop | State | (in) | of | Treatment | Practice | Treated |
| Almond | CA | 12 | 3 | 11 | 3 | 3 |
| Cherry | CA | 12 | 2 | 3 | 4 | 5 |
| Grape | CA | 6 | 3 | 6 | 3 | 3 |
| Sod | AZ | 6 | 2 | 4 | 3 | 3 |
| Sod | CA | 6 | 2 | 5 | 3 | 3 |
| Sod | NC | 6 | 3 | 7 | 4 | 4 |

Soil samples were analyzed for TOC on a percent basis (as dry weight) and for bulk density (e.g., grams of dry soil per cubic centimeter). Total carbon storage within each plot is calculated by multiplying the TOC content by the bulk density to quantify the mass of carbon in the sampling depth of the soil samples (either 6 inches or 12 inches) over a given area (e.g., acre). The mass of carbon is converted to carbon dioxide equivalents by dividing by the weight fraction of carbon dioxide that is carbon (27.7%).

The organic carbon results and carbon storage data are evaluated to assess if higher levels of organic carbon content were found in plots that had been treated with the composition.

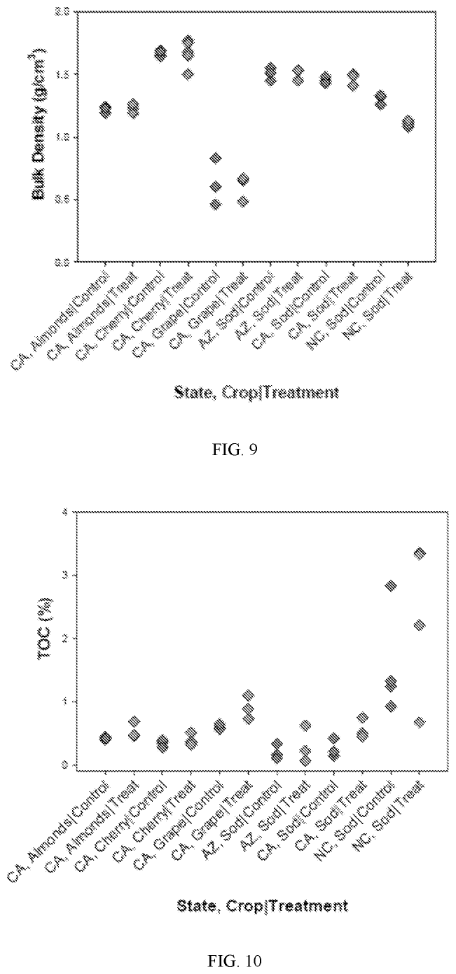

FIG. 9 shows the raw bulk density results from soils in untreated control and treated plots. The composition is not necessarily expected to have significant impacts on bulk density of soil, and these data demonstrate that the soil characteristics in control and treated plots are similar. In 5 out of 6 fields, the bulk density of control plots were within the same range as the treated plots.

Soil TOC in all of the plots evaluated was generally below 1% at all the farms tested except for the NC sod farm (FIG. 10), where TOC ranged from more than 3% to less than 1%. Soil TOC tended to be higher in the treated plots than in the control plots, with two instances of the opposite result.

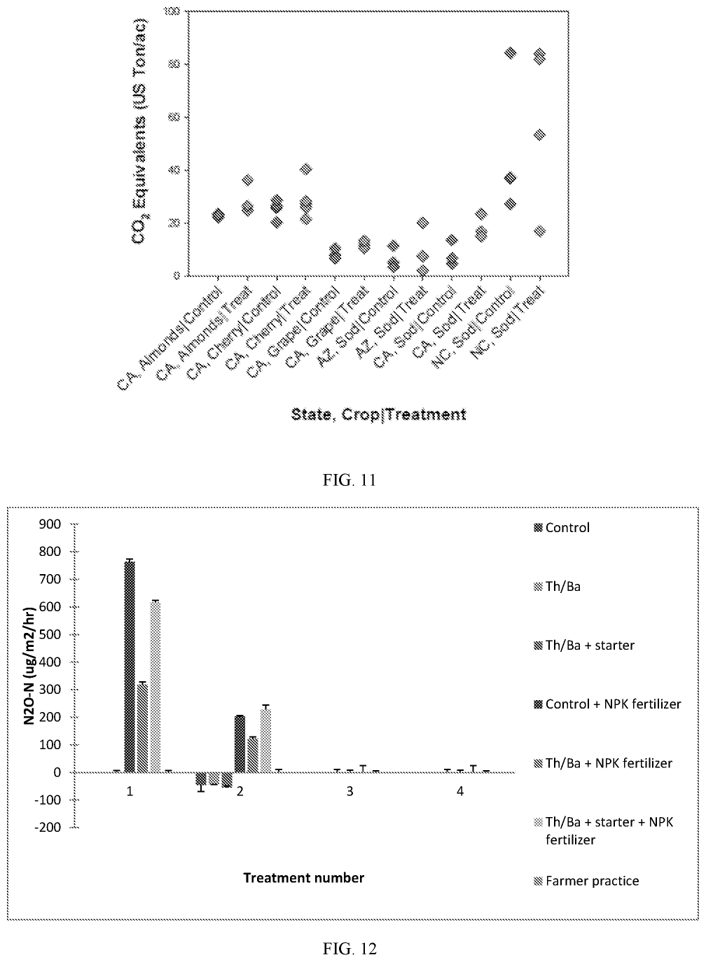

The bulk density results are combined with the TOC results to calculate the total carbon storage in soil as carbon dioxide equivalents (FIG. 11). Consistent with the TOC results, carbon storage in soil organic matter tended to be higher in the treated plots, regardless of the location or crop type. On average, carbon storage is higher in plots treated with the composition after two to three treatments than in adjacent control plots (see Table 8 below). The average results indicate a consistent trend of greater carbon storage in treated soils than control soils from all farms, although there is variability in TOC and bulk density.

TABLE 8
Sites and numbers of replicates analyzed for soil carbon

| | | | | Average C | |
|---|---|---|---|---|---|
| | | | | Sequestration | |
| | | | | Difference | |
| | | Numbers | Months | (US Tons | |
| | | of | Since First | of CO2 | % Difference in |
| Crop | State | Treatments | Treatment | Equivalents/ac)* | Treatment Plots |
| Almonds | CA | 3 | 11 | 6.2 | 27% |
| Cherry | CA | 2 | 3 | 3.3 | 13% |
| Crane | CA | 3 | 6 | 3.5 | 42% |
| Sod | AZ | 2 | 4 | 3.2 | 48% |
| Sod | CA | 2 | 5 | 10.0 | 121% |
| Sod | NC | 3 | 7 | 12.7 | 27% |

ac: acre
*Positive difference indicates average C storage in treatment plots was higher than in control plots. Negative difference indicates that average C storage in control plots was higher than in treatment plots. Carbon storage was calculated over the depth from which the soil samples were collected.

### Example 12—Soil Carbon Measurements for California Sod

A composition according to embodiments of the subject invention comprising Trichoderma harzianum and Bacillus amyloliquefaciens was mixed with NanoGro™, applied with a boom spray to sod fields and watered in with standard irrigation. One pre-dormancy treatment was made in October, which was followed by a NanoGro™ application approximately 30 days later. Treatments were stopped when soil temperature fell below 55° F.

Once soil temperatures rose above 55° F., the composition, mixed with NanoGro™, was applied once every 60 days followed by an additional NanoGro™ nutrient package 30 days after each treatment until harvest. Each treatment area was matched by an untreated section of the same size (standard grower's practice), as shown in Table 9 below.

TABLE 9
Treatment by plot.

| Plot | | Application Rate | |
|---|---|---|---|
| Number | Treatment composition | (vol./acre) | Acres |
| 1 | Standard Grower's Practice | N/A | 2.5 |
| | (UTC) | | |
| 2 | Standard Grower's Practice | N/A | 2.5 |
| | (UTC) | | |
| 3 | Th/Ba | 3 fl. oz./acre | 2.5 |
| | Humic acid | 0.2 L/acre | |
| | Kelp + | 0.4 L/acre | |
| | NanoGro ™ | 4 fl. oz./acre | |
| 4 | Th/Ba | 3 fl. oz./acre | 2.5 |
| | Humic acid | 0.2 L/acre | |
| | Kelp + | 0.4 L/acre | |
| | NanoGro ™ | 4 fl. oz./acre | |

Th/Ba = Trichoderma harzianum/Bacillus amyloliquefaciens

The plots were sampled and analyzed, and the results are reported below in Table 10.

TABLE 10
Bulk Density and Total Organic Carbon measurements.

| | Bulk Density | |
|---|---|---|
| Sample | (g/100 cc) | Carbon (TOC) % |
| Grower's Practice | 145 | 0.42 |
| Grower's Practice | 148 | 0.14 |
| Grower's Practice | 143 | 0.21 |
| Treated | 150 | 0.5 |
| Treated | 149 | 0.45 |
| Treated | 141 | 0.74 |

### Example 13—Soil Carbon Measurements for California Almonds

A composition according to embodiments of the subject invention comprising Trichoderma harzianum and Bacillus amyloliquefaciens was applied to soil in which almond trees were growing through a standard irrigation system. Three total treatments were performed according to Table 11 below.

TABLE 11
Treatment by plot.

| Plot | | Application Rate | |
|---|---|---|---|
| Number | Treatment composition | (vol./acre) | Acres |
| 1 | Standard Grower's Practice | N/A | 20 |
| | (UTC) | | |
| 2 | Th/Ba | 1.5 fl. oz./acre | 20 |
| | Humic acid | 0.2 L/acre | |
| | Kelp | 0.1 L/acre | |

Th/Ba = Trichoderma harzianum/Bacillus amyloliquefaciens

A 20-acre block of almond trees were treated and sampled, and a 20-acre block of untreated almonds were also sampled as a control. The results are outlined below in Tables 12 and 13.

TABLE 12
Bulk Density and Total Organic Carbon measurements.

| | Bulk Density | Carbon | BD | BD | OC | OC |
|---|---|---|---|---|---|---|
| Sample | (g/100 cc) | (TOC) % | (g/cm³) | (kg/ha) | (g/kg) | (Mg/ha) |
| Grower's | 124 | 0.4 | 1.24 | 3,720,000 | 4 | 14.88 |
| Practice | | | | | | |
| Grower's | 119 | 0.44 | 1.19 | 3,570,000 | 4.4 | 15.708 |
| Practice | | | | | | |
| Grower's | 123 | 0.42 | 1.23 | 3,690,000 | 4.2 | 15.498 |
| Practice | | | | | | |
| Treated | 123 | 0.45 | 1.23 | 3,690,000 | 4.5 | 16.605 |
| Treated | 119 | 0.68 | 1.19 | 3,570,000 | 6.8 | 24.276 |
| Treated | 126 | 0.47 | 1.26 | 3,780,000 | 4.7 | 17.7 |

TABLE 13
Average Soil Carbon Increase

| | | | metric tons- |
|---|---|---|---|
| | | | CO2e/acre |
| | Average Soil | | (Emissions |
| | OC (Mg/ha) | tons-C/acre | Prevented) |
| Treated | 19.55 | 8.72 | 29.10 |
| Grower's Practice | 15.36 | 6.85 | 22.86 |
| Soil Organic Carbon | 4.19 | 1.87 | 6.23 |
| Increase | | | |

### Example 14—Reduction in Nitrous Oxide Soil Emissions—Potatoes

Compositions according to embodiments of the subject invention (see Table 14 below) were tested for ability to reduce fertilizer requirements (e.g., NPK use) in potato fields. Reduced NPK use will directly help reduce soil salinity, nutrient run-off, and nitrous oxide emissions from soil.

Grower's practice plots were compared with various embodiments of the subject treatment compositions (Table 14). Four treatments were conducted, every two weeks (approx.) over the course of two months. A 60% reduction in nitrous oxide soil emissions was observed. FIG. 12.

TABLE 14
Potato trials - Nitrous oxide soil emissions from NPK fertilizer.
N₂O—N (μg/m²/hr)

| | Mean | Std Error | Mean | Std Error | Mean | Std Error | Mean | Std Error |
|---|---|---|---|---|---|---|---|---|
| Treatment | 1 | | 2 | | 3 | | 4 | |
| Control | 0 | 0 | −45.2974 | 24.16512 | 0 | 0 | 0 | 0 |
| Th/Ba | 0 | 0 | −42.698 | 21.66109 | 0 | 0 | 0 | 0 |
| Th/Ba + | 0 | 0 | −54.1886 | 27.80014 | 0 | 0 | 0 | 0 |
| starter | | | | | | | | |
| Control + | 764.7036 | 162.0165 | 202.9261 | 11.13024 | 0 | 0 | 0 | 0 |
| NPK fertilizer | | | | | | | | |
| Th/Ba + | 319.3095 | 83.91279 | 123.4818 | 64.72609 | 0 | 0 | 0 | 0 |
| NPK fertilizer | | | | | | | | |
| Th/Ba + | 617.7146 | 86.34354 | 229.2139 | 54.44751 | 0 | 0 | 0 | 0 |
| starter + | | | | | | | | |
| NPK fertilizer | | | | | | | | |
| Grower's | 0 | 0 | 0 | 0 | 0 | 0 | 0 | 0 |
| practice | | | | | | | | |
| (NPK fertilizer) | | | | | | | | |

Th/Ba = Trichoderma harzianum/Bacillus amyloliquefaciens
Control = no Th/Ba
Starter = see starter materials as described in Example 1, supra.
NPK fertilizer = 29-0-5 (N-P-K) (normalized to equal 100 lb. of N/acre).

The plots treated with the subject composition were also compared with plots where no fertilizer was used. This is of particular interest for non-fertilized crops/regenerative agriculture, such as in reforestation and pasture reclamation. The results showed that untreated plots served as nitrous oxide sinks, and treated plots sequestered nitrous oxide in even greater amounts (20% greater).

### REFERENCES

Brummell, M. E., and S. D. Siciliano. (2011). “Measurement of Carbon Dioxide, Methane, Nitrous Oxide, and Water Potential in Soil Ecosystems.” Methods in Enzymology. 496:115-137. Doi: 10.1016/B978-0-12-386489-5.00005-1. (“Brummell and Siciliano 2011”).
Gougoulias, C., Clark, J. M., & Shaw, L. J. (2014). The role of soil microbes in the global carbon cycle: tracking the below-ground microbial processing of plant-derived carbon for manipulating carbon dynamics in agricultural systems. Journal of the Science of Food and Agriculture, 94(12), 2362-2371. https://doi.org/10.1002/jsfa.6577
Government of Western Australia. (2018). “Carbon farming: reducing methane emissions from cattle using feed additives.” https://www.agric.wa.gov.au/climate-change/carbon-farming-reducing-methane-emissions-cattle-using-feed-additives. (“Carbon Farming 2018”).
Kumar, R., Pandey, S., & Pandey, A. (2006). Plant roots and carbon sequestration. Current Science, 91(7), 885-890. Retrieved from https://www.researchgate.net/profile/Rajeew_Kumar/publication/255642030_Plant_Roots_and_Carbon_Sequestration/links/547ec84c0cf2c1e3d2dc29f0/Plant-Rootsand-Carbon-Sequestration.pdf
Lange, M., Eisenhauer, N., Sierra, C., & Bessler, H. (2015). Plant diversity increases soil microbial activity and soil carbon storage. Nature Communications, 6(6707), 1-8. Retrieved from https://www.nature.com/articles/ncomms7707
Malik, A., Blagodatskaya, E., & Gleixner, G. (2013). Soil microbial carbon turnover decreases with increasing molecular size. Soil Biology & Biochemistry, 62, 115-118. Retrieved from https://www.sciencedirect.com/science/article/pii/S0038071713000849
Pidwirny, M. (2006). “The Carbon Cycle”. Fundamentals of Physical Geography, 2nd Edition. Date Viewed. http://www.physicalgeography.net/fundamentals/9r.html. (“Pidwirny 2006”).
Six, J., Frey, S., Thiet, R., & Batten, K. (2006). Bacterial and fungal contributions to carbon sequestration in agroecosystems. Soil Science Society of America, 70, 555-569.
Sparks, D. L., Page, A. L., Helmke, P. A., Loeppert, R. H., Soltanpou, P. N., Tabatabai, M. A., Johnston, C. T., Sumner, M. E. (1996). Methods of Soil Analysis. Part 3: Chemical Methods. Number 5 in the Soil Science Society of America Book Series. Madison, Wis.
United States Environmental Protection Agency. (2016). “Climate Change Indicators in the United States.” https://www.epa.gov/sites/production/files/2016-08/documents/climate_indicators_2016.pdf. (“EPA Report 2016”).
United States Environmental Protection Agency. (2016). “Overview of Greenhouse Gases.” Greenhouse Gas Emissions. https://www.epa.gov/ghgemissions/overview-greenhouse-gases. (“Greenhouse Gas Emissions 2016”).
Xu, X., Thornton, P. E., & Post, W. M. (2013). A global analysis of soil microbial biomass carbon, nitrogen and phosphorus in terrestrial ecosystems. Global Ecology and Biogeography, 22(6), 737-749. https://doi.org/10.1111/geb.12029
Zhou, J., Xue, K., Xie, J., Deng, Y., Wu, L., & Cheng, X. (2012). Microbial mediation of carbon-cycle feedbacks to climate warming. Nature Climate Change, 2, 106-110. Retrieved from https://www.nature.com/articles/doi:10.1038%2Fnclimate1331

1-13. (canceled)

14. The composition of claim 17, comprising a glycolipid selected from sophorolipids, mannosylerythritol lipids, rhamnolipids and trehalose lipids.

15. The composition of claim 17, comprising a lipopeptide selected from surfactin, iturin, fengycin, arthrofactin and lichenysin.

16. (canceled)

17. A composition for reducing a greenhouse gas, improving carbon utilization, and/or enhancing sequestration of carbon, the composition comprising at least one ingredient selected from:
a) Wickerhamomyces anomalus, and/or at least one growth by-product of the Wickerhamomyces anomalus, wherein the growth by-product is selected from biosurfactants and enzymes;
b) a bacteria selected from Bacillus subtilis, Bacillus amyloliquefaciens, Myxococcus xanthus, Azotobacter vinelandii, Frateuria aurantia, Pseudomonas chlororaphis and Dyadobacter fermenters; and
c) Trichoderma harzianum.

18. The composition of claim 17, further comprising one or more additional microorganisms selected from Starmerella bombicola, Saccharomyces boulardii, Pichia occidentalis, Pichia kudriavzevii, and Meyerozyma guilliermondii.

19-20. (canceled)

21. The composition of claim 17, comprising a bacterium selected from Bacillus subtilis, Bacillus amyloliquefaciens, Myxococcus xanthus, Azotobacter vinelandii, Frateuria aurantia, Pseudomonas chlororaphis and Dyadobacter fermenters.

22-23. (canceled)

24. The composition of claim 17, comprising 1×10⁶ to 1×10¹³ CFU/ml of Trichoderma harzianum, and 1×10⁶ to 1×10¹³ CFU/ml of Bacillus amyloliquefaciens.

25. (canceled)

26. A method of reducing the amount of a deleterious atmospheric gas present in the earth's atmosphere, the method comprising:
applying a composition of claim 17 to a site that is a source of the deleterious atmospheric gas,
optionally applying nutrients for microbial growth to the site, and optionally
conducting measurements to assess the effect of the composition on the reduction of the deleterious atmospheric gas.

27. (canceled)

28. The method of claim 26 wherein the composition comprises a yeast selected from Wickerhamomyces anomalus, Starmerella bombicola, Saccharomyces boulardii, Pichia occidentalis, Pichia kudriavzevii, and Pichia guilliermondii (Meyerozyma guilliermondii).

29. The method of claim 26, wherein the composition comprises a Trichoderma spp.

30. The method of claim 29, wherein the Trichoderma is Trichoderma harzianum.

31. The method of claim 26, wherein the composition comprises a bacterium selected from Bacillus subtilis, Bacillus amyloliquefaciens, Pseudomonas chlororaphis, Myxococcus xanthus, Azotobacter vinelandii, Frateuria aurantia and Dyadobacter fermenters.

32. (canceled)

33. The method of claim 26, wherein the deleterious atmospheric gas is carbon dioxide, nitrous oxide, or methane.

34. The method of claim 26, wherein the site is soil.

35. The method of claim 34, wherein one or more microorganisms of the composition colonize the soil and/or roots of plants growing in the soil, and wherein the colonization causes:
an increase in foliar volume, stem diameter, trunk diameter, root growth, and/or numbers of the plants,
an increase in microbial biomass in the soil,
improved soil biodiversity, and/or
increased uptake of organic plant secretions by microorganisms.

36. (canceled)

37. The method of claim 35, wherein atmospheric carbon dioxide is reduced by enhancing vegetative carbon utilization and storage.

38. The method of claim 35, wherein carbon sequestration is enhanced.

39. The method of claim 35, wherein the composition comprises Bacillus amyloliquefaciens, and wherein the Bacillus amyloliquefaciens lowers the pH of the soil and enhances solubilization of nitrogen into plant-usable compounds.

40. The method of claim 39, wherein a need for applying nitrogen-containing fertilizer to the soil is reduced, thereby reducing atmospheric nitrous oxide.

41-42. (canceled)

43. The method of claim 35, wherein the plant is a crop plant selected from citrus, tomato, sod, turf, potato, sugarcane, grapes, lettuce, almond, onion, carrot, berries and cotton.

44. (canceled)

45. The method of claim 35, wherein the plant is a grass, shrub, or herb growing in a pasture or a sod or turf farm.

46. The method of claim 34, wherein the composition is applied to the soil using an irrigation system.

47. The method of claim 26, wherein the site is a manure lagoon or a rice paddy.

48. The method of claim 47, wherein the microorganisms and/or growth by-products of the composition control methanogenic microorganisms present in the manure lagoon or rice paddy, thus reducing atmospheric methane.

49-50. (canceled)

51. The method of claim 48, wherein the composition further enhances biomass of rice plants growing in a rice paddy.

52. The method of claim 26, wherein, prior to applying the composition to the site, the method comprises:
assessing the site for local conditions,
determining a preferred formulation for the composition that is customized for the local conditions.

53. The method of claim 52, wherein the local conditions assessed comprise one or more of: soil type, species of soil microbiota, amount and/or type of soil organic content, amount and/or type of GHG precursor substrates, amount and/or type of fertilizers or other soil additives or amendments present, crop and/or plant conditions, types of plants, numbers of plants, age and/or health of plants, amount and/or type of GHG emissions, current climate, current season/time of year, and mode and/or rate of application of the composition.

54-57. (canceled)

58. The method of claim 26, wherein carbon content of a site is measured by quantifying above-ground and/or below-ground biomass of plants at the site, quantifying carbon content of litter, woody debris and/or soil organic content at the site.

59. The method of claim 26, wherein the number of carbon credits used by an operator involved in agriculture, livestock production, logging, pasture management, waste management, aviation, oil and gas production, or other industries is reduced.
